(19) United States
(12) Patent Application Publication
(10) Pub. No.: US 2026/0059420 A1
(43) Pub. Date: Feb. 26, 2026

(54) METHODS AND SYSTEMS FOR SERVICE ENABLER DATA DELIVERY FLOW MANAGEMENT

(71) Applicant: InterDigital Patent Holdings, Inc., Wilmington, DE (US)

(72) Inventors: Dale SEED, Allentown, PA (US); Quang LY, North Wales, PA (US); Catalina MLADIN, Hatboro, PA (US); Lu LIU, Conshohocken, PA (US)

(73) Assignee: InterDigital Patent Holdings, Inc., Wilmington, DE (US)

(21) Appl. No.: 19/103,038

(22) PCT Filed: Aug. 11, 2023
(86) PCT No.: PCT/US2023/072091

§ 371 Date: Feb. 11, 2025

Related U.S. Application Data
(60) Provisional application No. 63/371,319, filed on Aug. 12, 2022.

(51) Int. Cl. H04W 36/38; H04W 4/50

(52) U.S. Cl. CPC H04W 36/385; H04W 4/50

(57) ABSTRACT

A SEALDD server may receive a request to establish a SEALDD flow, wherein the SEALDD flow facilitates a transfer of VAL data between a VAL client endpoint and a first VAL server endpoint, and wherein the request comprises at least one of VAL client endpoint information and first VAL server endpoint information. The SEALDD server may establish a SEALDD flow associated with the first VAL server and associated with at least one VAL client endpoint. The SEALDD server may subscribe to a core network and receive a notification from the core network indicating a UE mobility event associated with a UE upon which the VAL client is hosted. The SEALDD server may determine to transfer the VAL client to a second VAL server. The SEALDD server may transfer the SEALDD flow to a different SEALDD server associated with the second VAL server.

### CROSS-REFERENCE TO RELATED APPLICATIONS

This application claims the benefit of U.S. Patent Application No. 63/371,319.

### BACKGROUND

In legacy third generation partnership project (3GPP) systems, support for Service Enabler Architecture Layer for Verticals (SEAL) may be provided on User Equipment (UE) devices and servers, with the SEAL functional entities on the UE and the server grouped into SEAL client(s) and SEAL server(s) respectively. While the SEAL offers a common set of services to the vertical application layer (VAL), there exists a need for an improved service enabler that assists with distribution, storage, and delivery of application content and application data for VAL applications.

### SUMMARY

This summary is provided to introduce a selection of concepts in a simplified form that are further described below in the detailed description. This summary is not intended to identify key features or essential features of the claimed subject matter, nor is it intended to be used to limit the scope of the claimed subject matter. Furthermore, the claimed subject matter is not limited to limitations that solve any or all disadvantages noted in any part of this disclosure.

Methods and apparatuses are described herein for improving SEAL data delivery (SEALDD) flow management. Systems and methods are described for SEALDD to support real-time transport layer continuity during UE mobility scenarios, for example UE relocation from one Edge Application Server (EAS) to another EAS. Further systems and methods are described for SEALDD to support data transmission quality measurements and APIs that allow application clients and/or application servers to support receiving and configuring such measurements. Further systems and methods are described for SEALDD to support data storage service. For example, a SEALDD server may store data destined for a constrained device that may be sleeping, and when or after the device awakens, the SEALDD server may send the data to the device.

### BRIEF DESCRIPTION OF THE DRAWINGS

The following detailed description is better understood when read in conjunction with the appended drawings. For the purposes of illustration, examples are shown in the drawings; however, the subject matter is not limited to specific elements and instrumentalities disclosed. In the drawings:

FIG. 1 shows an example system.

FIG. 2 shows an example system.

FIG. 3 shows an example system.

FIG. 4 shows an example system.

FIG. 5 shows an example system.

FIG. 6 shows an example method.

FIG. 7 shows an example method.

FIG. 8 shows an example method.

FIG. 9 shows an example method.

FIG. 10 shows an example method.

FIG. 11 shows an example method.

FIG. 12 shows an example method.

FIG. 13 shows an example method.

FIG. 14 shows an example method.

FIG. 15 shows an example method.

FIG. 16 shows an example method.

FIG. 17 shows an example method.

FIG. 18 shows an example method.

FIG. 19 shows an example method.

FIG. 20 shows an example method.

FIG. 21 shows an example method.

FIG. 22 shows an example method.

FIG. 23 shows an example system.

FIG. 24A shows an example communications system.

FIG. 24B shows an example apparatus configured for wireless communications.

FIG. 24C shows an example system.

FIG. 24D shows an example system.

FIG. 24E shows an example system.

FIG. 24F shows an example system.

FIG. 24G shows an example system.

### DETAILED DESCRIPTION

Methods and apparatuses are described herein for Service Enabler Data Delivery Flow Management.

One issue recognized in the SEALDD study is the need for SEALDD to support real-time transport layer continuity for scenarios where a UE relocates to a different EAS (e.g., UE mobility scenarios).

Another issue recognized in the SEALDD study is the need for SEALDD to support data transmission quality measurements and API that allow application clients and servers to support receiving as well as configuring these measurements.

Another issue recognized in the SEALDD study is the need for SEALDD to support data storage services. For example, the SEALDD server may store data destined for constrained devices that may be sleeping. When or after the devices wake-up, the SEALDD server may send the data to the devices.

The following abbreviations and definitions may be used herein:

| | |
|---|---|
| 3GPP | Third Generation Partnership Project |
| 5GS | 5G System |
| AC | Application Client |
| AF | Application Function |
| API | Application Programming Interface |
| AS | Application Server |
| ASP | Application Service Provider |
| AVP | Attribute Value Pair |
| CN | Core Network |
| EAS | Edge Application Server |
| EDN | Edge Data Network |
| EEC | Edge Enabler Client |
| EEL | Edge Enabler Layer |
| EES | Edge Enabler Server |
| ECS | Edge Configuration Server |
| GUI | Graphical User Interface |
| KPI | Key Performance Indicator |
| MAC | Media Access Control |
| MNO | Mobile Network Operator |
| NEF | Network Exposure Function |
| PLMN | Public Land Mobile Network |
| QoE | Quality of Experience |
| QoS | Quality of Service |
| SCEF | Service Capability Exposure Function |
| SEAL | Service Enabler Architecture Layer for Verticals |
| SEALDD | SEAL Data Delivery Enabler |
| UE | User Equipment |
| VAL | Vertical Application Layer |

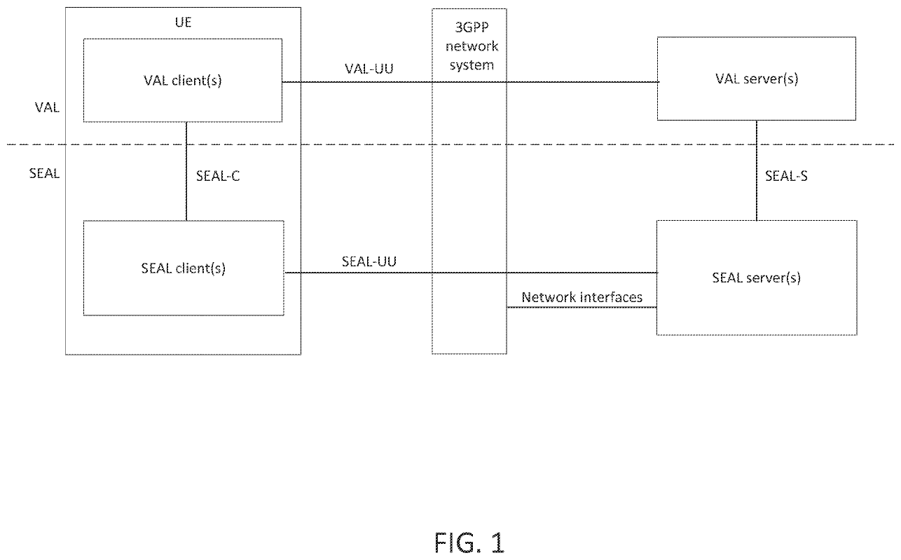

FIG. 1 shows the architecture for the Service Enabler Architecture Layer for Verticals (SEAL) defined by the 3GPP SA6 working group. The SEAL functional entities on the UE and the server may be grouped into SEAL client(s) and SEAL server(s) respectively. The SEAL may consist of a common set of services (e.g. group management, location management) and reference points. The SEAL may offer its services to the vertical application layer (VAL). The SEAL client(s) may communicate with the SEAL server(s) over the SEAL-UU reference points. The SEAL client(s) may provide the service enabler layer support functions to the VAL client(s) over SEAL-C reference points. The VAL server(s) may communicate with the SEAL server(s) over the SEAL-S reference points. The SEAL server(s) may communicate with the underlying 3GPP network systems using the respective 3GPP interfaces specified by the 3GPP network system.

The 3GPP SA6 Release 18 study on the SEAL data delivery enabler (SEALDD) recognizes the need for a service enabler that assists with distribution, storage, and delivery of application content or data for VAL applications.

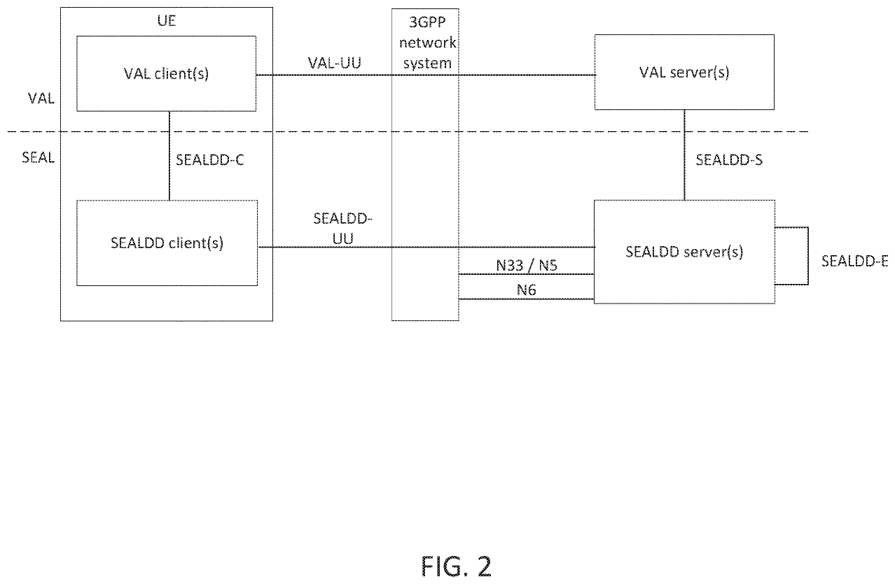

FIG. 2 shows the SEALDD architecture.

One Key Issue recognized in the SEALDD study is the need for SEALDD to support real-time transport layer continuity for scenarios where a UE relocates to a different EAS (e.g., UE mobility scenarios).

A second Key Issue recognized in the SEALDD study is the need for SEALDD to support data transmission quality measurements and API that allow application clients or servers to support receiving as well as configuring these measurements.

A third Key Issue recognized in the SEALDD study is the need for SEALDD to support data storage services. For example, the SEALDD server may store data destined for constrained devices that may be sleeping. When or after the devices wake-up, the SEALDD server may send the data to the devices.

The 3GPP SA6 Release 18 SEALDD study has yet to define SEALDD functionality to address the three issues presented above. For example, functionality to support end-to-end transport layer continuity of service for cases where a UE relocates to a different EAS, and functionality which allows applications to configure and retrieve data transmission quality measurements that are collected by the SEALDD layer is currently lacking.

The disclosure proposes SEALDD flow management functionality to address the three Key Issues presented above, denoted as Key Issues #2, #3, and #5, respectively, of the 3GPP SA6 Release 18 SEALDD study. Within the SEALDD client and SEALDD server, the following SEALDD flow management functionality is defined:

A SEALDD server that supports SEALDD flow management functionality comprising:
1) Receiving a request from a VAL server to create, update, retrieve, discover, or tear down a SEALDD flow wherein the request comprises SEALDD flow context information such as but not limited to the information elements defined in Table 1,
2) Processing the request to create, update, retrieve, discover, or tear down a SEALDD flow using any SEALDD flow context information provided in the request and any SEALDD flow context information stored by the SEALDD server or retrieved from another SEALDD server or SEALDD client,
3) Sending a response to a VAL server indicating that the request to create, update, retrieve, discover, or tear down a SEALDD flow has completed wherein the response comprises SEALDD flow context information such as but not limited to the information elements defined in Table 1.
4) Receiving a SEALDD Service Subscription request from a VAL server wherein the request comprises VAL server endpoint information such as but not limited to the information elements defined in Table 12,
5) Processing the SEALDD service subscription request by creating or updating SEALDD flows for each of the specified VAL server endpoints
6) Sending a response for the SEALDD service subscription indicating SEALDD flows that have been created or updated for the specified VAL server endpoints
7) Receiving a request from a VAL server to transmit a VAL message to a VAL client or another VAL server via a SEALDD flow
8) Processing the request by constructing one or more SEALDD messages wherein the VAL message is encapsulated in the one or more SEALDD messages, wherein the constructing of the SEALDD message may comprise segmenting the VAL message into multiple SEALDD messages or aggregating multiple VAL messages into a single SEALDD message based on message segmentation and aggregation policies configured for the SEALDD flow.
9) Sending the SEALDD messages to one or more remote SEALDD clients or servers over one or more redundant transports, wherein sending the SEALDD messages may comprise store-and-forwarding the SEALDD messages based on a store-and-forward schedule configured for the SEALDD flow, wherein sending the SEALDD messages may comprise throttling the SEALDD messages based on a throttling policy configured for the SEALDD flow
10) Generating measurements for the SEALDD flow based on a measurement policy configured for the SEALDD flow, wherein the measurement policy comprises rules for generating different types of measurements as defined in Table 1.
11) Receiving requests from VAL servers to access the measurements collected for a SEALDD flow and providing measurements to the VAL server,
12) Detecting a trigger condition to synchronize SEALDD flow context and exchanging SEALDD context with a SEALDD client or another SEALDD server such that the context remains synchronized,
13) Detecting a trigger condition to transfer SEALDD flow context and sending SEALDD context to a SEALDD client or another SEALDD server.

A SEALDD client that supports SEALDD flow management functionality comprising:
1) Receiving a request from a VAL client to create, update, retrieve, discover, or tear down a SEALDD flow wherein the request comprises SEALDD flow context information such as but not limited to the information elements defined in Table 1,
2) Processing the request to create, update, retrieve, discover, or tear down a SEALDD flow using any SEALDD flow context information provided in the request and any SEALDD flow context information stored by the SEALDD client or retrieved from another SEALDD client or server,
3) Sending a response to a VAL client indicating that the request to create, update, retrieve, discover, or tear down a SEALDD flow has completed wherein the response comprises SEALDD flow context information such as but not limited to the information elements defined in Table 1.
4) Receiving a SEALDD service request from a VAL client wherein the request comprises VAL client endpoint information such as but not limited to the information elements defined in Table 12,
5) Processing the SEALDD service request by creating or updating SEALDD flows for each of the specified VAL client endpoints
6) Sending a response for the SEALDD service request indicating SEALDD flows that have been created or updated for the specified VAL server endpoints
7) Receiving a request from a VAL client to transmit a VAL message to another VAL client or server via a SEALDD flow
8) Processing the request by constructing one or more SEALDD messages wherein the VAL message is encapsulated in the one or more SEALDD messages, wherein the constructing of the SEALDD message may comprise segmenting the VAL message into multiple SEALDD messages or aggregating multiple VAL messages into a single SEALDD message based on message segmentation and aggregation policies configured for the SEALDD flow.
9) Sending the SEALDD messages to one or more remote SEALDD clients or servers over one or more redundant transports, wherein sending the SEALDD messages may comprise store-and-forwarding the SEALDD messages based on a store-and-forward schedule configured for the SEALDD flow, and wherein sending the SEALDD messages may comprise throttling the SEALDD messages based on a throttling policy configured for the SEALDD flow
10) Generating measurements for the SEALDD flow based on a measurement policy configured for the SEALDD flow, wherein the measurement policy comprises rules for generating different types of measurements as defined in Table 1.
11) Receiving requests from VAL clients to access the measurements collected for a SEALDD flow and providing measurements to the VAL client or server,
12) Detecting a trigger condition to synchronize SEALDD flow context and exchanging SEALDD context with a SEALDD server or another SEALDD client such that the context remains synchronized,
13) Detecting a trigger condition to transfer SEALDD flow context and sending SEALDD context to a SEALDD server or another SEALDD client.

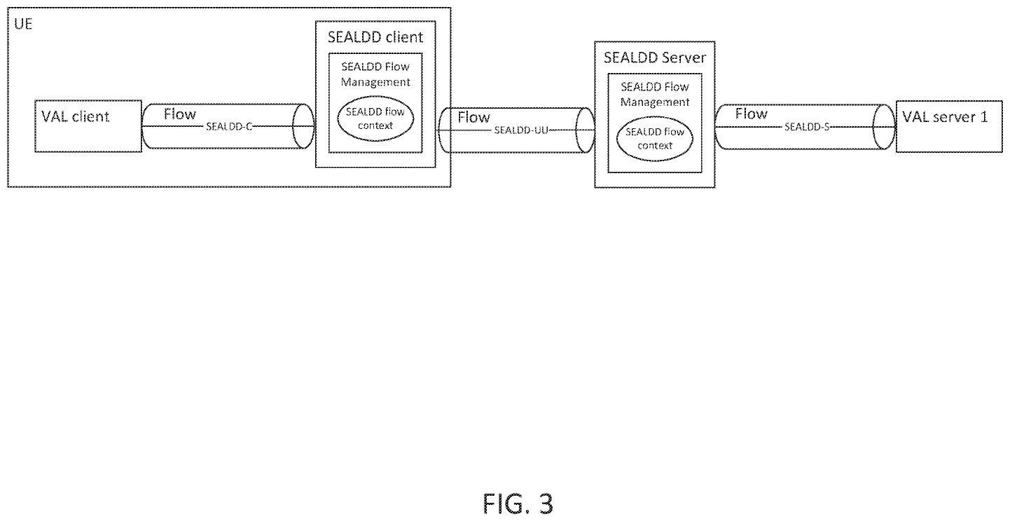

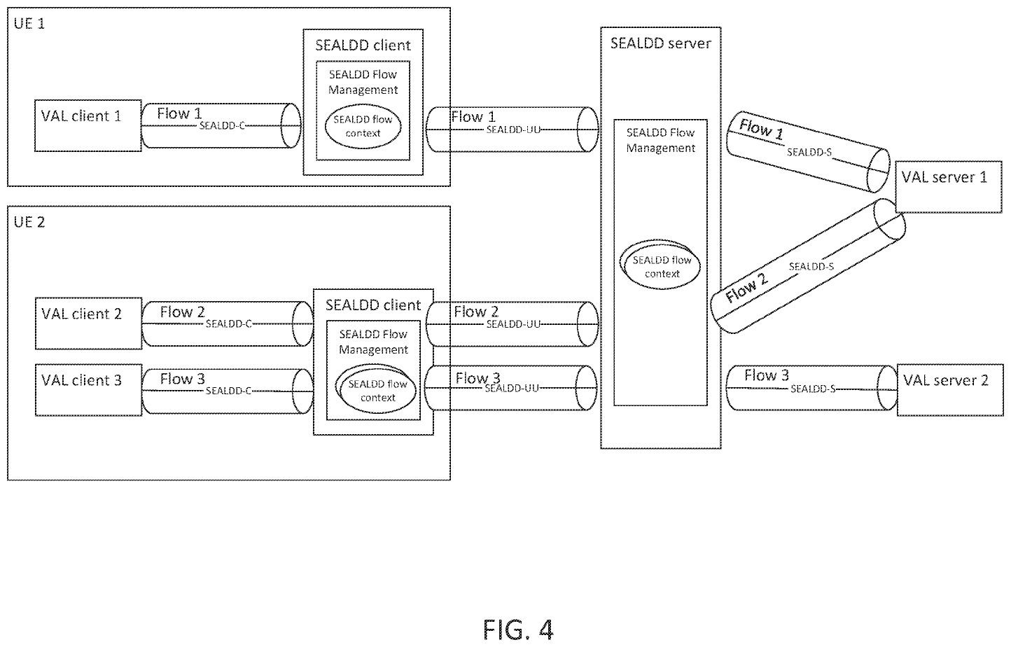

To provide multi-tenancy support within SEALDD, flow management functionality is defined as shown in FIG. 3 and FIG. 4. For each end-to-end flow of messages exchanged between a VAL client and VAL server, a SEALDD flow is established. A SEALDD flow comprises one or more underlying transports that are used to exchange SEALDD messages between a SEALDD client and server and ultimately between a VAL client and server. A SEALDD flow also comprises additional functionality capable of collecting measurement information related to exchange of messages via the flow. A SEALDD flow also comprises advanced message processing functionality that supports store-and-forwarding, segmenting and reassembling, throttling and caching of messages exchanged via a flow.

To establish and manage a SEALDD flow, SEALDD flow management functionality is proposed within SEALDD clients and servers. The SEALDD flow management functionality of a SEALDD client or server may support storing and maintaining of SEALDD context information that the SEALDD client or server uses to manage SEALDD flows. The proposed SEALDD flow management functionality enables SEALDD clients and servers to perform various types of SEALDD flow aware operations such as but not limited to the following:
1) Independently manage end-to-end QoS on an individual SEALDD flow basis.
2) Establish and teardown redundant transports for a given flow based on VAL client and server requirements.
3) Collect measurements on an individual SEALDD flow basis.
4) Cache VAL response messages on an individual SEALDD flow basis.
5) Manage store-and-forwarding, segmentation and reassembly, aggregation and throttling of VAL messages on an individual SEALDD flow basis.

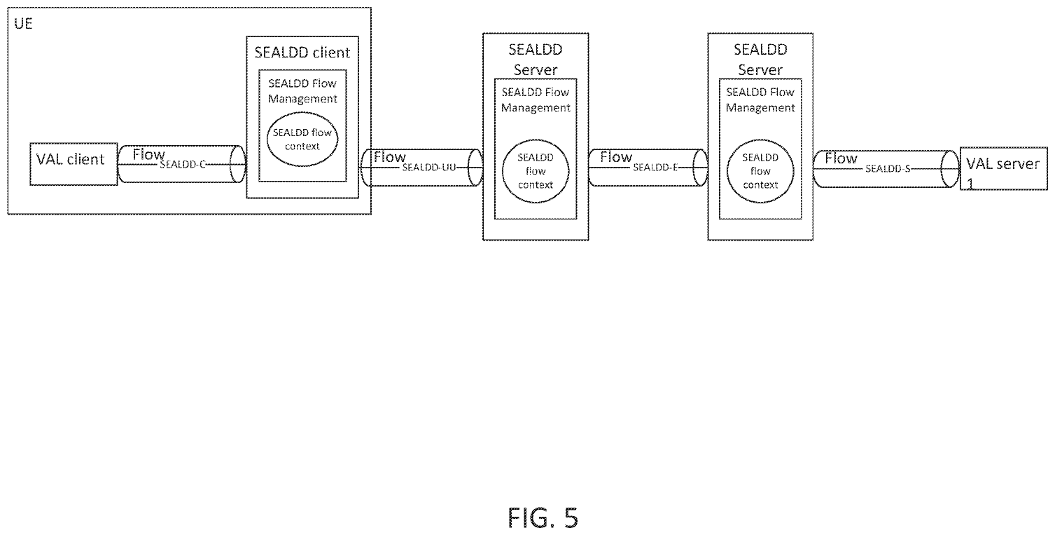

As shown in FIG. 5, a flow may span across multiple SEALDD servers. In this case, one SEALDD server may communicate with another SEALDD server via their respective SEALDD flow management functionality. For example, a SEALDD server may receive a SEALDD request and the SEALDD server may forward the request to another SEALDD server. This may be required for use cases involving a VAL server which is connected to a different SEALDD server than the one that a SEALDD client is connected to.

SEALDD flow context may be comprised of one or more information elements such as but not limited to those defined in Table 1. Separate instances of flow context may be maintained for each individual flow. The flow context may be stored and maintained on a single entity in the system (e.g., on a SEALDD server) or distributed across multiple entities in the system (e.g., on a SEALDD client and SEALDD server). If SEALDD flow context is stored and maintained in a distributed manner, methods such as the ones proposed in this invention may be used to maintain synchronization between the multiple copies of the SEALDD flow context. In addition, if SEALDD flow context is stored and maintained in a distributed manner, then some entities may only require storing a subset of the context (e.g., a SEALDD client may only require storing a subset of information while the SEALDD server may store the complete set of information).

TABLE 1
SEALDD Flow Context Information Elements

| Information Element | Description |
|---|---|
| Flow context ID/ | Identifier and/or address of this SEALDD flow context |
| Address | information. This identifier and/or address may comprise |
| | information such as but not limited to the following: |
| | IP address or MAC address of SEALDD client or |
| | server hosting this flow context |
| | Ports of SEALDD client or server hosting this flow context |
| | Transport protocol(s) used to access this flow context |
| | Resource identifier (e.g., URI path, topic name, etc.) |
| | of this flow context |
| Flow ID | Identifier of SEALDD flow associated with this SEALDD |
| | flow context. |
| Source Endpoint(s) | VAL client or server endpoint(s) that send messages via this |
| | SEALDD flow. Each endpoint in this list may comprise the |
| | following information: |
| | IP address(s) of VAL client or server endpoint |
| | Port(s) of VAL client or server endpoint |
| | Transport protocol(s) of VAL client or server endpoint |
| | Resource identifier(s) of VAL client or server endpoint |
| | Identifier and/or type indicator of the service |
| | supported by the VAL client or server endpoint |
| Destination | VAL client or server endpoint(s) that receive messages via |
| Endpoint(s) | this SEALDD flow. Each endpoint in this list may comprise |
| | the following information: |
| | IP address(s) of VAL client or server endpoint |
| | Port(s) of VAL client or server endpoint |
| | Transport protocol(s) of VAL client or server endpoint |
| | Resource identifier(s) of VAL client or server endpoint |
| | Identifier and/or type indicator of the service |
| | supported by the VAL client or server endpoint |
| Flow Enable/Disable | Control used to enable or disable the flow |
| Flow Status | Current status of flow: |
| | Enabled - Flow is available for VAL clients and |
| | servers to exchange VAL messages with one another |
| | Disabled - Flow is currently unavailable for VAL |
| | clients and servers to exchange VAL messages with |
| | one another |
| MSGin5G | Defines whether MSGin5G services are required to be used |
| requirements | for the flow. In addition to specifying whether or not |
| | MSGin5G service is required, additional info may also be |
| | specified such as: |
| | MSGin5G transports required (e.g., IP, NIDD, SMS) |
| | MSGin5G message aggregation required |
| | MSGin5G message store-and-forwarding required |
| | MSGin5G message segmentation and reassembly required |
| Remote flow | Identifier(s) and/or address(s) of SEALDD flow context |
| context ID(s) | information stored on remote SEALDD client(s) or server(s) |
| | and that is associated with this SEALDD flow context |
| | information (i.e., context associated with the same |
| | SEALDD flow). Information may comprise the following: |
| | IP address(s) of remote SEALDD client(s) or server(s) |
| | Port(s) of remote SEALDD client(s) or server(s) |
| | Transport protocol(s) of remote SEALDD client(s) or server(s) |
| | E.g., HTTP, NIDD, SMS etc. |
| | Resource identifier(s) (e.g., URI path, topic name, etc.) |
| Transport | Defines requirements that may be used to determine the |
| requirements | transports required for this SEALDD flow. For example, the |
| | requirements may be expressed in terms of a type (e.g., |
| | HTTP, NIDD, SMS, etc.) and quantity of redundant |
| | transports required. Alternatively, the requirements may be |
| | expressed in higher-level terms such as required level of |
| | QoS and/or reliability. The SEALDD client or server may in |
| | turn translate this higher-level requirement into the need for |
| | redundant transports to satisfy this requirement. |
| Transport status | Transport status indicating whether transport(s) have been |
| | established for this SEALDD flow and information related |
| | to the transports. For example, whether redundant transports |
| | are required and how many, the type of transports required |
| | such as HTTP, MSGin5G, NIDD, etc . . . |
| Message entry | The SEALDD client or server address associated with this |
| point | SEALDD client or server for which the source VAL client |
| | or server endpoint(s) may target messages towards for this |
| | flow. Messages received by SEALDD client or server via |
| | this address are processed and sent to destination VAL |
| | client or server endpoint(s) via this SEALDD flow. This |
| | address of the SEALDD client or server may comprise one |
| | or more of the following: |
| | IP address of SEALDD client or server |
| | Ports of SEALDD client or server used to receive |
| | VAL client or server requests for this flow |
| | Transport protocol(s) supported |
| | Resource identifier (e.g., URI path, topic name, etc.) |
| | used by SEALD client or server to receive VAL |
| | client or server requests for this flow |
| Message exit | SEALDD client or server address associated with this |
| point | SEALDD client or server for which the destination VAL |
| | client or server endpoint(s) receive messages from for this |
| | flow. For example, destination VAL client or server |
| | endpoint(s) may poll or subscribe to this address to receive |
| | messages via the SEALDD flow. This address may |
| | comprise one or more of the following: |
| | IP address of SEALDD client or server |
| | Ports of SEALDD client or server used to receive |
| | VAL client or server requests for this flow |
| | Transport protocol(s) supported |
| | Resource identifier (e.g., URI path, topic name, etc.) |
| | used to receive requests from SEALDD client or |
| | server for this flow |
| Caching policies | Defines VAL message caching policies pertaining to this |
| | flow which may be specified by a VAL client or VAL |
| | server and may comprise: |
| | Caching enabled/disabled - An indicator |
| | defining if caching of VAL response messages is |
| | enabled or disabled for this SEALDD flow |
| | Caching lifetime - an absolute or relative time |
| | defining how long a VAL response message that |
| | is processed by this SEALDD flow may be |
| | cached before it is expired |
| | Maximum cache size - The maximum storage |
| | resources (e.g., bytes) allocated to this SEALDD |
| | flow to cache VAL response messages. When |
| | the maximum storage resources have been |
| | exceeded, the SEALDD client or server may |
| | replace the least recently used cached VAL |
| | response message with a new VAL response |
| | message to be cached. |
| | VAL response caching filter - Criteria defining |
| | which VAL response messages are to be cached |
| | by SEALDD client or server for this flow. For |
| | example, criteria may be defined based on a |
| | VAL client or server endpoint ID or address |
| | originating a VAL response message, the type of data/ |
| | content comprised within the VAL response message, etc. |
| | VAL response cache access policy - Access |
| | control rules defining which VAL clients and servers |
| | are permitted to access cached VAL response messages |
| | Note - a SEALDD client or server may use deep packet |
| | inspection techniques to inspect VAL messages and detect |
| | which messages are requests and responses, the VAL client or |
| | server originating a request or response VAL message, the |
| | type of data/content comprised within a VAL response, etc. |
| Cached VAL response | VAL response messages cached by the SEALDD client or |
| messages | server for this SEALDD flow. The VAL response messages |
| | may be cached within one or more elements within the flow |
| | context itself (e.g., inline within this information element). |
| | Alternatively, the cached response messages may be stored |
| | elsewhere by the SEALDD client or server (e.g., in another |
| | resource or topic). |
| Measurement policy(s) | Measurements to collect for this SEALDD flow which may |
| | comprise the following: |
| | VAL message transport measurements for flow |
| | (e.g., average reliability, latency and throughput |
| | for messages processed via flow) |
| | VAL message caching measurements for flow |
| | (e.g., cache hit/miss totals and rates for requests |
| | processed via flow) |
| | VAL message load balancing measurements for |
| | flow (e.g., quantity of requests forwarded to each |
| | VAL/SEALDD server of flow) |
| | VAL message store-and-forward measurements |
| | (e.g., quantity of requests stored, average store |
| | time before forwarding requests of flow) |
| | VAL message aggregation measurements (e.g., |
| | quantity of requests aggregated (in total, on |
| | average) for flow) |
| | Subscription/Notification measurements (e.g., |
| | quantity of subscriptions received, quantity of |
| | notifications sent for flow) |
| Measurements | Actual measurements collected and stored for this SEALDD |
| | flow. For examples of the types of measurements collected |
| | and stored see “Required measurements” above. |
| | The measurements may be stored within this flow context |
| | itself (e.g., inline within this information element). |
| | Alternatively, the measurements may be stored elsewhere |
| | by a SEALDD client or server (e.g., in another resource or |
| | topic). If stored elsewhere, the SEALDD client or server |
| | may maintain a link (e.g., URI, topic name, etc.) to the |
| | stored measurements within this flow context. |
| | Measurements may also be accessed by VAL clients and servers. |
| Load balancing | Rules defining how a SEALDD client or server is to load |
| policy(s) | balance requests received from source endpoint(s) of the |
| | flow (e.g., VAL client(s)) such that the requests are |
| | distributed across a group of destination endpoints for the |
| | flow (e.g., VAL servers). |
| Store-and-forward | Rules defining when (e.g., a schedule) the SEALDD client |
| policy(s) | or server for the flow may store requests received from |
| | source endpoint(s) and when to forward the stored requests |
| | to the destination endpoint(s). The rules may comprise a |
| | store-and-forward time window defining a maximum |
| | duration of time that the SEALDD client or server may |
| | store a message before forwarding the message. The rules |
| | may also comprise filters defining the specific types of VAL |
| | messages or the applicable source and/or destination |
| | endpoints that store-and-forward processing is to be applied. |
| Message aggregation | Rules defining when the SEALDD client or server for the |
| policy(s) | flow aggregates multiple requests received from source |
| | endpoint(s) into a single SEALDD request that the |
| | SEALDD client or server forwards to destination |
| | endpoint(s). The rules may comprise an aggregation time |
| | window defining a maximum duration of time that the |
| | SEALDD client or server may wait for additional messages |
| | to aggregate with a received message before the SEALDD |
| | client forwards the SEALDD request. |
| Message throttling | Rules defining when the SEALDD client or server for the |
| policy(s) | flow may throttle requests received from source endpoint(s). |
| | The rules may comprise at least one of a time window |
| | defining a maximum quantity of requests from source |
| | endpoint(s) or a total quantity of bytes that may be received |
| | and processed by the SEALDD client or server for the flow. |
| Message segmentation | Rules defining maximum size of VAL messages that may |
| policies | be encapsulated and sent within a single SEALDD message. |
| | Based on these policies, a SEALDD client and server may |
| | determine whether segmentation and reassembly of VAL |
| | messages are required. |
| Access control policies | Rules that define which entities are permitted to at least one |
| | of access the SEALDD flow or the context information |
| | associated with the flow, the type of SEALDD operations |
| | the entities are permitted to perform using the flow or |
| | operations performed upon the context information |
| | associated with the flow, the times when the entities are |
| | permitted to perform the operations, and the locations from |
| | which the entities are permitted to perform the operations |
| | from. The rules may comprise information elements, for |
| | example: |
| | Entities - Identifiers of permitted VAL clients or |
| | servers and/or SEALDD clients or servers permitted |
| | Operations - Types of operations allowed on the |
| | SEALDD flow context itself or performed using the flow |
| | Schedule - Times when permitted entities are |
| | allowed to perform permitted operations |
| | Location - specified locations (e.g. GPS, geo-fence) |
| | from which permitted entities are permitted to |
| | perform operations |
| Subscription(s) | Subscription(s) from VAL clients or servers or SEALDD |
| | clients or servers to this SEALDD flow context. |
| | Subscriptions may comprise information such as but not |
| | limited to one or more of the following: |
| | Subscriber Identity - Identifier of VAL client or |
| | server or SEALDD client or server |
| | Notification Criteria - one or more events of interest |
| | to the Subscriber, where the events may comprise |
| | conditions and the conditions may specify variables, |
| | operators, and values. Where the variables may |
| | refer to information elements defined in the |
| | SEALDD flow context data or measurements stored |
| | within the flow context. The variables may also refer |
| | to SEALDD events such as the transmitting or |
| | receiving of a message via the SEALDD flow context. |
| | The operators may comprise (=, !=, <, >, <=, >=). |
| | The values may comprise numbers, strings, |
| | or complex types. Some examples of events for |
| | which notifications may be generated may comprise |
| | the following: |
| | Notifications if/when new flows are created |
| | Notifications if updates occur to context |
| | information associated with a flow |
| | Notifications if/when VAL messages are sent |
| | or received via flow |
| | Notifications if/when VAL messages are |
| | cached for a flow |
| | Notifications if/when measurements |
| | associated with a flow are collected |
| | Notifications if/when maximum rate of |
| | messages associated with a flow is reached |
| | Notifications if/when maximum byte limit of cached |
| | messages associated with a flow is reached. |
| | Notifications if/when requests associated |
| | with a flow are stored and/or forwarded |
| | Notifications if/when requests associated |
| | with a flow are aggregated |
| | Notifications if/when requests associated |
| | with a flow are segmented |
| | Notifications if/when access to a flow is denied |
| | Notification Targets - one or more addresses notifications |
| | may be sent to if/when the notification criteria are met |

Procedures are defined for the management of SEALDD flows. The proposed procedures comprise SEALDD flow management operations that may be initiated by VAL clients and servers that target SEALDD clients and servers. VAL clients and servers may initiate these operations based on the occurrence of trigger conditions such as a VAL client or server starting up, a VAL client or server receiving a request from an application or user, or a VAL client or server detecting a change in application or user requirements or configuration. Although the procedures defined in this invention refer to a VAL client or server initiating these requests, one skilled in the art may recognize that other entities may issue these flow management operations. For example, an analytics server (ADAES) may initiate a request to retrieve or subscribe to receive measurements for one or more SEALDD flows from a SEALDD server.

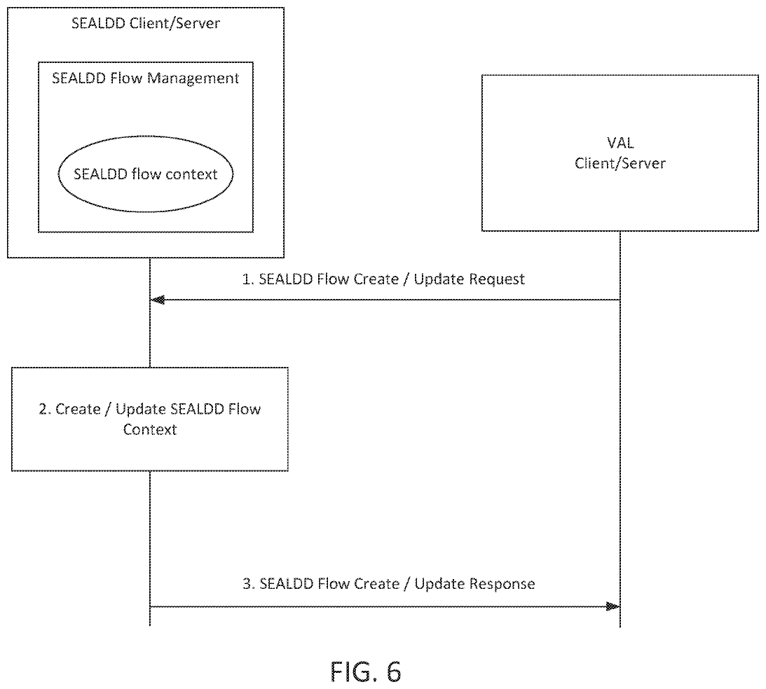

As shown in FIG. 6, VAL clients and servers may establish a SEALDD flow by initiating a request to a SEALDD client or server. A SEALDD flow may be established by creating a new flow for a VAL client or server requesting use of SEALDD services. SEALDD context information as shown in Table 1 may be created to manage the flow. If a SEALDD flow has already been created, a SEALDD client or server may update the existing flow (e.g., to enable a disabled flow) by adding, modifying, or deleting context from the SEALDD flow.

Step 1: To establish or modify a SEALDD flow, a VAL client or server issues a SEALDD flow create or update request to a SEALDD client or server, where the request may comprise one or more of the information elements defined in Table 2. In the case of an update request, the VAL client or server may comprise a SEALDD Flow identifier.

Note that the procedure to establish or modify a SEALDD flow may be triggered by other VAL requests providing the necessary information, e.g. MSGin5G message request. The SEALDD server may translate such requests into SEALDD management requests based on the parameters of the request, as well as on pre-configured information such as SEALDD local policies, VAL server or VAL client specific policies, contextual information (location, time of day, network status, etc.).

TABLE 2
SEALDD Flow Create/Update Request Information Elements

| Information Element | Description |
|---|---|
| SEALDD flow context | See Table 1 for a list of SEALDD flow context information |
| information | elements that may be comprised in this request. |
| SEALDD client or | Address of the SEALDD client or server used to receive |
| server address | SEALDD flow create/update requests which may comprise |
| | the following: |
| | IP address of the targeted SEALDD client or server |
| | Port that the targeted SEALDD client or server |
| | receives SEALDD flow create/update requests on |
| | Identifier of a resource or topic (e.g., URI, topic name, etc.) |
| | hosted on the targeted SEALDD client or server which the |
| | SEALDD flow context is to be created (e.g., as a child |
| | resource or sub-topic of the parent) or updated |
| VAL client or server ID | Identifier of the VAL client or server initiating this request |

Step 2: Upon receiving the SEALDD flow create or update request, the targeted SEALDD client or server may process the request by first checking whether the VAL client or server originating the request has permissions to create or update context for the SEALDD flow on the targeted SEALDD client or server. This check may be performed by the SEALDD client or server checking that the VAL client or server ID specified in the request matches an ID specified in the access control privileges of the SEALDD client or server. The check may also comprise verifying the type of SEALDD operation being performed is allowed as well as the operation is allowed to be performed at the current time and from the current location that the VAL client or server resides. If allowed, the SEALDD client or server creates or updates the SEALDD flow context. When creating or updating the SEALDD flow context, the SEALDD client or server may also perform one or more of the following operations based on SEALDD flow context information comprised within the request:
1) Assign a SEALDD flow context ID and/or address to the flow context if one is not already assigned or comprised in the request.
2) Identify one or more SEALDD flows associated with the flow context. If a flow context is being created and a flow is not specified in the request, then a new flow may be generated, and a new flow ID may be assigned to the flow by the SEALDD client or server. This new flow ID may be stored within the flow context.
3) Store the source and destination flow endpoints specified in the request within the stored flow context
4) Determine any remote SEALDD clients or servers of the source or destination flow endpoints. This determination may involve using information specified in the request and querying information stored locally on the SEALDD client or server, information stored on remote SEALDD client(s) or server(s), or information stored on another node in the network.
5) Determine transport-level characteristics of the delivery method or technology (e.g. NIDD), channel, bearer, etc. needs to be established in order to fulfill the VAL requirements in the request. The transport-level determination may also be based on pre-configured information such as SEALDD local policies, VAL server or VAL client specific policies, as well as contextual information (location, time of day, network status, etc.). As part of this determination, the SEALDD server may invoke exposed Core Network functionality comprising receiving measurements or analytics related to the Core Network or client UE status, determining UE location, capabilities, or subscription information, etc.
6) Within this step, the SEALDD server may also determine whether a specific application-level mechanism is necessary in order to enable the corresponding transport-level delivery method. For example, the SEALDD server determines whether MSGin5G messaging, and procedures should be used for delivery to the client on the UE. If the SEALDD flow ID is configured in the received request, determine if any remote SEALDD flow context(s) exist for this flow ID. This determination may involve querying information stored locally on the SEALDD client or server, information stored on remote SEALDD client(s) or server(s), or information stored on another node in the network.
7) Determine whether to enable the flow. This determination may be based on information specified in the flow enable element of the request. Alternatively, the flow may be enabled upon creation of the flow by the SEALDD client or server.
8) Update the flow status to reflect whether the flow is enabled or disabled.
9) Determine whether redundant transports are required for the SEALDD flow. This determination may be made by analyzing the redundant transport requirement information provided in the request. If a redundant transport is deemed necessary, then the SEALDD client or server may attempt to establish the redundant transports between the SEALDD client and SEALDD server associated with the VAL client and server endpoints of the flow.
10) Update to the SEALDD flow context's redundant transport status to reflect whether or not redundant transports have been established or not for the flow.
11) Assign/configure message entry and exit point resources (e.g., ports, URIs, etc.) within the SEALDD client or server that VAL clients and servers use to send and receive VAL messages via the SEALDD flow.
12) Based on any caching policies specified within the request and/or based on local policies of the SEALDD client or server, enable or disable caching of VAL response messages associated with the flow. Also configure caching lifetime, maximum cache size, caching filter, and/or any cache access policies based on information provided in the request.
13) Based on any measurement policies specified within the request and/or based on local policies of the SEALDD client or server, collect and store corresponding types of measurements.
14) Based on load balancing policies within the request and/or based on local policies of the SEALDD client or server, start to load balance incoming requests to the flow by determining which VAL server or SEALDD server to forward the incoming request to such that requests are balanced across all VAL servers.
15) Based on store-and-forward policies within the request and/or based on local policies of the SEALDD client or server, enable store-and-forwarding of requests for the flow.
16) Based on message aggregation policies within the request and/or based on local policies of the SEALDD client or server, enable aggregation of requests for the flow.
17) Based on message throttling policies within the request and/or based on local policies of the SEALDD client or server, enable throttling of requests for the flow.
18) Based on message segmentation policies within the request and/or based on local policies of the SEALDD client or server, enable message segmentation and reassembly of requests for the flow.
19) Based on access control policies within the request and/or any local access control policies of the SEALDD client or server, configure the access control policies for the created SEALDD flow.
20) Based on subscription information within the request and/or any local subscription policies of the SEALDD client or server, create and configure subscriptions to the SEALDD flow.

Step 3: Generate and return a SEALDD flow create or update response to the VAL client or server that originated the request. Where the response may comprise one or more of the information elements defined in Table 3.

TABLE 3
SEALDD Flow Context Create Response Information Elements

| Information Element | Description |
|---|---|
| SEALDD flow | See Table 1 for a list of proposed |
| context information | SEALDD Flow context information elements. |
| Status | Indication of whether the request was |
| | successfully processed or not. |

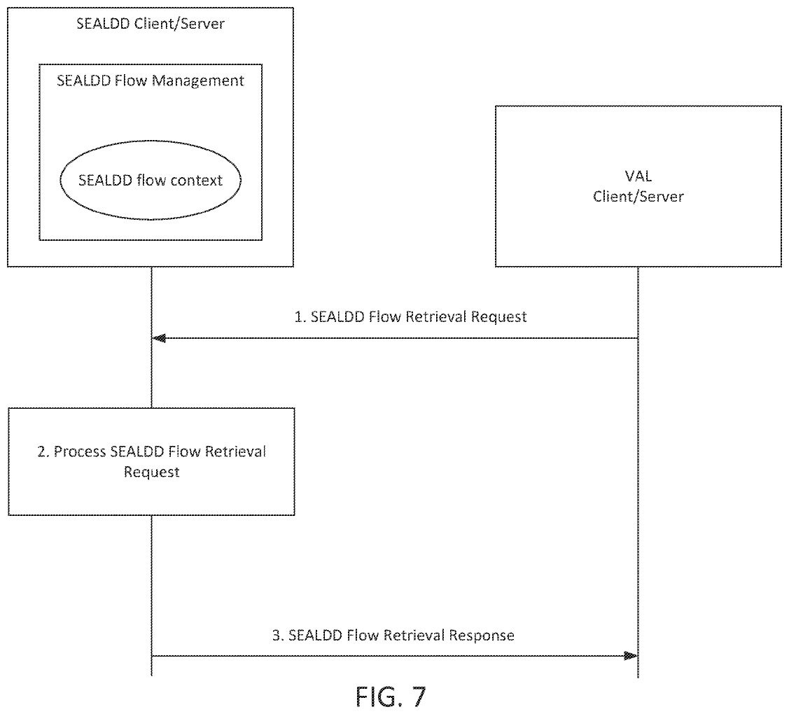

As shown in FIG. 7, VAL clients and servers may initiate a request to a SEALDD client or server to retrieve or discover information regarding one or more SEALDD flows.

Step 1: A VAL client or server issues a request to a SEALDD client or server to retrieve context for one or more SEALDD flows. Alternatively, the retrieval request may be used to discover one or more SEALDD flows that match one or more specified criteria. The request may comprise one or more of the information elements defined in Table 4.

TABLE 4
SEALDD Flow Retrieval/Discovery Request Information Elements

| Information Element | Description |
|---|---|
| SEALDD flow context | One or more criteria that may consist of variables, operators |
| filter criteria | and/or values. Where the variables may refer to SEALDD |
| | flow context information elements. The operators may |
| | comprise operators such as =, !=, <, >, <=, >=. The values |
| | may comprise numbers, strings, or complex types. Some |
| | examples of criteria may comprise a flow having: |
| | a flow context ID equal to a specific value |
| | a flow ID equal to a specific value |
| | a specified source and/or destination flow endpoint |
| | a status of enabled or disabled |
| | redundant transports |
| | specified caching policy(s) |
| | specified measurement policy(s) |
| | specified load balancing policy(s) |
| | specified store-and-forward policy(s) |
| | specified message aggregation policy(s) |
| | specified message throttling policy(s) |
| | specified message segmentation policy(s) |
| | specified access control policy(s) |
| | specified subscription(s) |
| target address | Address of the SEALDD client or server or another entity in |
| | the system that is capable of receiving and processing |
| | SEALDD flow retrieval/discovery requests. The address |
| | may comprise the following: |
| | IP address of the target |
| | Port of the target capable of receiving SEALDD |
| | flow retrieval/discovery requests on |
| | Identifier of a resource or topic of the target |
| VAL client or server ID | Identifier of the VAL client or server initiating the request |

Step 2: Upon receiving the request to retrieve or discover context for SEALDD flows, the targeted SEALDD client or server may process the request by first checking whether the VAL client or server originating the request has permissions. This check may be performed by the SEALDD client or server checking that the VAL client or server ID specified in the request matches an ID specified in the access control privileges of the SEALDD client or server. The check may also comprise verifying the type of SEALDD operation being performed is allowed as well as the operation is allowed to be performed at the current time and from the current location that the VAL client or server resides. If allowed, the SEALDD client or server processes the request. The SEALDD client or server may check whether the request comprises filter criteria. If present, the SEALDD client or server compares the specified filter criteria against the SEALDD flow contexts that the SEALDD client or server hosts to determine whether any flow contexts match the filter criteria.

Step 3: If one or more SEALDD flow contexts are found to match the filter criteria, then representations of the flow context(s) are returned in a response to the VAL client or server that originated the request. Otherwise, an error indication is returned in the response. The response may comprise one or more of the information elements defined in Table 5.

TABLE 5
SEALDD Flow Context Retrieval Response Information Elements

| Information Element | Description |
|---|---|
| SEALDD flow context | See Table 1 for a list of proposed SEALDD |
| information | flow context information elements that may |
| | be comprised for each flow context returned |
| | in the response. |
| Status | Indication of whether the request was |
| | successfully processed or not. |

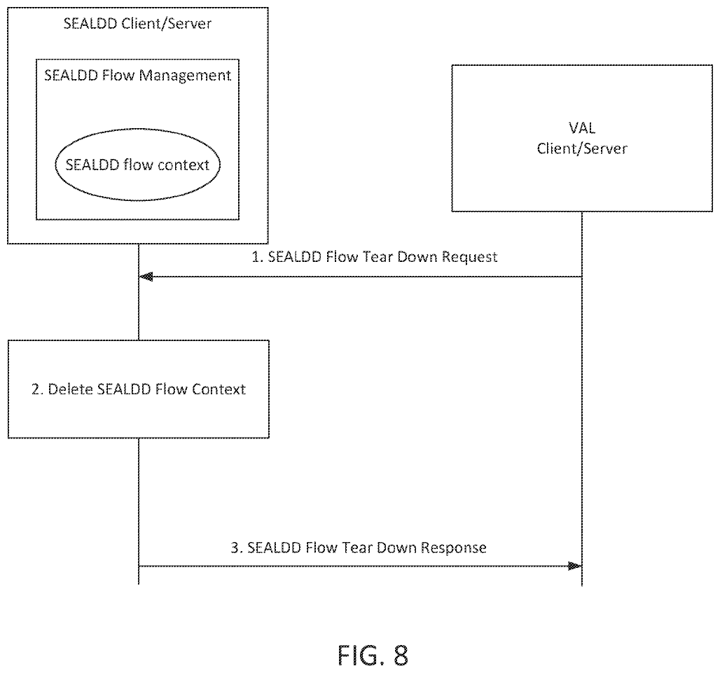

As shown in FIG. 8, VAL clients and servers may initiate a request to a SEALDD client or server to tear down a SEALDD flow by deleting its flow context.

Step 1: A VAL client or server may tear down a SEALDD flow by issuing a SEALDD flow context deletion request to a SEALDD client or server. The request may comprise one or more of the information elements defined in Table 6.

TABLE 6
SEALDD Flow Context Tear Down Request Information Elements

| Information Element | Description |
|---|---|
| SEALDD flow context | One or more criteria such as those specified in Table 4. |
| filter criteria | Note, rather than a filter criteria, this information |
| | element may instead be realized as a SEALDD flow ID. |
| SEALDD client or | Address of the SEALDD client or server used to receive |
| server | SEALDD flow tear down requests which may comprise the |
| | following: |
| | IP address of the targeted SEALDD client or server |
| | Port that the targeted SEALDD client or server |
| | receives SEALDD flow tear down requests on |
| | Identifier of a resource or topic that the targeted SEALDD |
| | client or server receives SEALDD flow tear down requests at |
| VAL client or server ID | Identifier of the VAL client or server initiating the request |

Step 2: Upon receiving the SEALDD flow tear down request, the targeted SEALDD client or server may process the request by first checking whether the VAL client or server originating the request has permissions to delete a SEALDD flow context on the SEALDD client or server. This check may be performed by the SEALDD client or server checking that the VAL client or server ID specified in the request matches an ID specified in the access control privileges of the SEALDD client or server. The check may also comprise verifying the type of SEALDD operation being performed is allowed as well as the operation is allowed to be performed at the current time and from the current location that the VAL client or server resides. If allowed, the SEALDD client or server processes the request. The SEALDD client or server may perform one or more of the following operations based on SEALDD flow context information comprised within the request:
1) Delay processing of the tear down request until the SEALDD client or server finishes any outstanding VAL message transmission or reception processing.
2) Trigger the tear-down of any underlying transports (redundant or non-redundant) associated with the flow (and any corresponding PDU sessions).
3) Stop collecting measurements associated with the flow.
4) Notify VAL clients and servers subscribers of the flow, that the flow is being torn down.
5) Notify remote SEALDD clients and servers having context for the flow, that the flow is being torn down.
6) Reject any subsequent requests attempting to transmit or receive VAL messages via the SEALDD flow.
7) Delete any stored measurements associated with the flow.
8) Delete any cached VAL response messages associated with the flow.
9) Delete any stored (buffered) messages associated with the flow.
10) Delete any access control policies associated with the flow.
11) Delete any subscriptions associated with the flow and stop sending notifications to subscribers.

Step 3: Generate and return a SEALDD flow tear down response to the VAL client or server that originated the request. Where the response may comprise one or more of the information elements defined in Table 7.

TABLE 7
SEALDD Flow Context Deletion Response Information Elements

| Information Element | Description |
|---|---|
| SEALDD flow context | See Table 1 for a list of proposed SEALDD |
| information | flow context information elements that may be |
| | incorporated for each flow context deleted. |
| Status | Indication of whether the SEALDD flow was |
| | successfully torn down or not. |

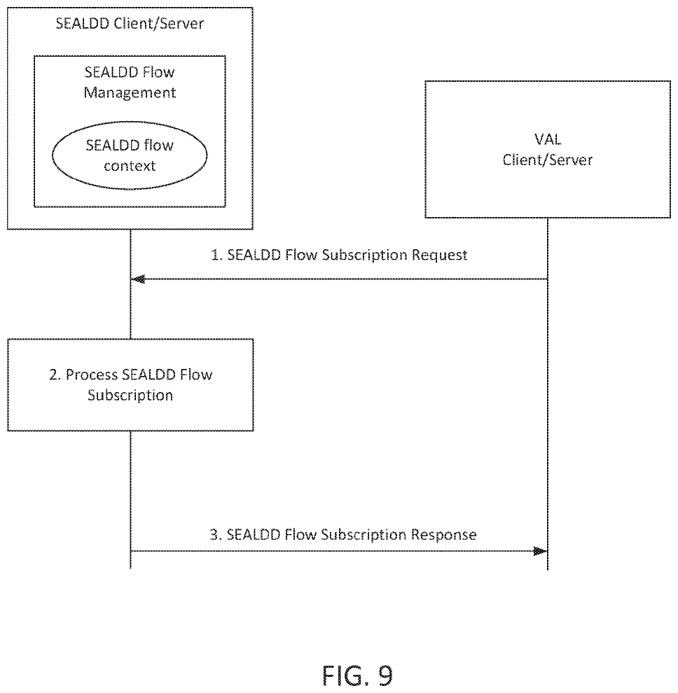

As shown in FIG. 9, VAL clients and servers may initiate a request to a SEALDD client or server to subscribe to receive notifications regarding SEALDD flow(s).

Step 1: A VAL client or server issues a SEALDD context subscription request to a SEALDD client or server, where the request may comprise one or more of the information elements defined in Table 8.

TABLE 8
SEALDD Flow Context Subscription
Request Information Elements

| Information Element | Description |
|---|---|
| SEALDD flow | See notification criteria defined in Table 1. |
| notification criteria | |
| Targeted SEALDD | Information regarding a targeted SEALDD flow that |
| flow | may comprise the following: |
| | IP address of the targeted SEALDD client or server |
| | Port that the targeted SEALDD client or server |
| | receives SEALDD flow context subscriptions |
| | requests on |
| | Identifier of a targeted SEALDD flow |
| | Identifier or address (e.g., URI) of targeted |
| | SEALDD flow context information stored on |
| | SEALDD client or server. |
| VAL client or | Identifier of the VAL client or server initiating |
| server ID | the request |

Step 2: Upon receiving the SEALDD flow subscription request, the targeted SEALDD client or server may process the request by first checking whether the VAL client or server originating the request has permissions to subscribe to a SEALDD flow on the SEALDD client or server. This check may be performed by the SEALDD client or server checking that the VAL client or server ID specified in the request matches an ID specified in the access control privileges of the SEALDD client or server. The check may also comprise verifying the type of SEALDD operation being performed is allowed as well as the operation is allowed to be performed at the current time and from the current location that the VAL client or server resides. If allowed, the SEALDD client or server processes the request. Upon processing the request, the SEALDD client or server may begin to monitor if or when the notification criteria specified in the request has been met.

Step 3: Generate and return a SEALDD flow subscription response to the VAL client or server that originated the request. Where the response may comprise one or more of the information elements defined in Table 9.

TABLE 9
SEALDD Flow Subscription Response Information Elements

| Information Element | Description |
|---|---|
| Subscription ID | Identifier of the SEALDD flow subscription |
| | that has been created |
| SEALDD flow context | See Table 1 for a list of proposed SEALDD |
| information | Flow context information elements. |
| Status | Indication of whether the request was |
| | successfully processed or not. |

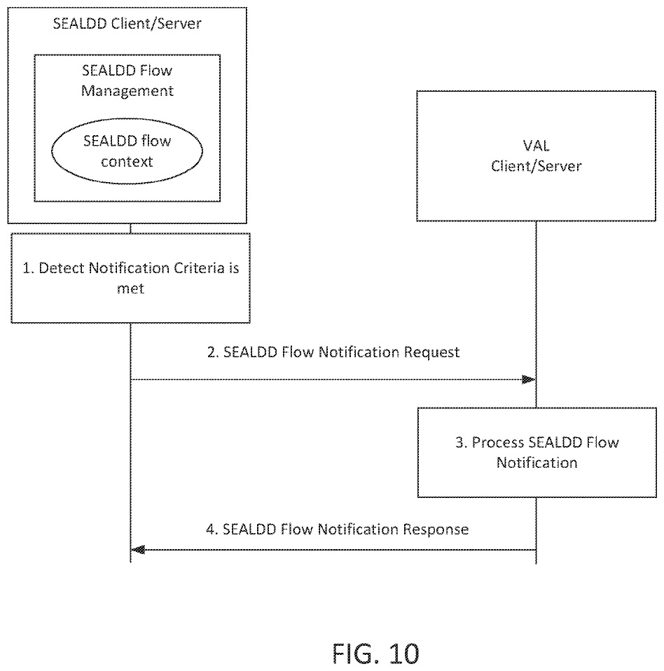

As shown in FIG. 10, VAL clients and servers may receive a notification from a SEALDD client or server regarding a SEALDD flow.

Step 1: If a SEALDD client or server detects that the notification criteria defined within a SEALDD flow subscription has been met, the SEALDD client or server may generate a SEALDD notification that may comprise but is not limited to one or more of the information elements defined in Table 10.

TABLE 10
SEALDD Flow Notification Request Information Elements

| Information Element | Description |
|---|---|
| Notification ID | Identifier of this SEALDD notification |
| Subscription ID | Identifier of the SEALDD flow subscription associated with |
| | this notification |
| Flow ID | Identifier of the SEALDD flow associated with this |
| | notification |
| SEALDD flow context | See Table 1 for a list of SEALDD flow context information |
| information | elements that may be incorporated. |
| VAL message(s) | One or more VAL messages that a SEALDD client or |
| | server receives and forwards via the notification to a VAL |
| | client or server. |
| SEALDD | One or more SEALDD measurements collected by a |
| measurement(s) | SEALDD client or server. See Table 1 for examples of |
| | SEALDD measurements. |
| SEALDD flow event(s) | One or more events related to a SEALDD flow that have |
| | been detected by a SEALDD client or server that may |
| | comprise the following: |
| | maximum rate of VAL messages in a flow reached |
| | VAL message(s) could not be delivered |
| | Availability SEALDD flow endpoints have changed |
| Targeted VAL client | Information regarding the targeted VAL client or server of |
| or server | the notification: |
| | IP address of the targeted VAL client or server |
| | Port that the targeted VAL client or server receives |
| | SEALDD flow notifications on |
| | Identifier of a resource or topic (e.g., URI, topic name, etc.) |
| | that the VAL client or server receives SEALDD flow notifications |
| SEALDD client or | Identifier of the SEALDD client or server initiating the |
| server ID | notification request |

Step 2: Upon receiving the SEALDD flow notification request, the VAL client or server may perform one or more operations such as but not limited to the following:
1) Extract and process VAL request and response message(s) incorporated within the notification
2) Extract and process SEALDD measurements incorporated within the notification
3) Extract and process SEALDD flow context information incorporated within the notification to detect a SEALDD flow being created, modified, enabled, disabled, or torn down
4) Extract and process SEALDD events incorporated within the notification to detect events such as but bit limited to the following: the maximum rate of VAL messages processed within a flow has been reached and throttling of messages is required, One or more VAL messages could not be delivered to their targeted VAL client or server (e.g., due to unavailability of targeted client or server), The current or scheduled availability of one or more SEALDD flow endpoints has changed (e.g., VAL client or server has disconnected or reconnected to the network)
5) Perform one or more actions in response to a SEALDD flow notification comprising at least one of the following: Throttle or schedule the transmission of VAL requests (e.g., adjust the schedule of when VAL client or server initiates the sending of VAL messages to other VAL clients or servers).

Step 3: The VAL client or server may generate and return a SEALDD flow notification response to the SEALDD client or server that originated the notification request. Where the notification response may comprise one or more of the information elements defined in Table 11.

TABLE 11
SEALDD Flow Context Notification
Response Information Elements

| Information Element | Description |
|---|---|
| Notification ID | Identifier of SEALDD notification |
| Status | Indication of whether the request was |
| | successfully processed or not. |

An alternative to VAL client or servers initiating SEALDD flow management operations based on the aforementioned procedures, is SEALDD client and servers may perform SEALDD flow management operations in an automated or delegated manner on behalf of VAL clients or servers. For example, a SEALDD client or server may perform SEALDD flow management operations as part of the processing of higher-level operations such as a SEALDD Service Subscription request that a SEALDD server receives from a VAL server or a SEALDD Service request that a SEALDD client receives from a VAL client.

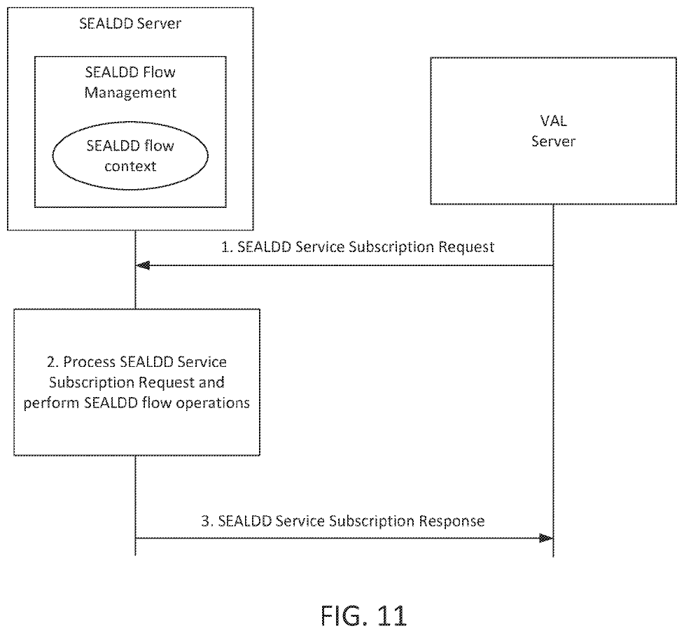

As shown in FIG. 11, an alternative to VAL servers initiating explicit requests to create, retrieve, update, delete and subscribe to a SEALDD flow on a SEALDD server, is for the SEALDD server to perform SEALDD flow management operations on behalf of the VAL server when the SEALDD server receives and processes a SEALDD Service Subscription request from a VAL server.

Step 1: VAL server issues a SEALDD Service Subscription request to the SEALDD server that comprises one or more of the information elements defined in Table 12.

TABLE 12
Enhanced SEALDD Service Subscription Information Elements

| Information Element | Description |
|---|---|
| List of VAL server | A VAL server may support one or more VAL server |
| endpoints | endpoints which the VAL server uses to send and/or receive |
| | VAL messages to and/or from VAL clients or other VAL |
| | servers. For each supported VAL server endpoint, one or |
| | more of the following information elements may be specified: |
| | Identifier of SEALDD flow associated with VAL |
| | server endpoint (if known) |
| | IP address that is bound to VAL server endpoint |
| | IP port that is bound to VAL server endpoint |
| | Relative path that is bound to VAL server endpoint |
| | Scheduled availability for sending or receiving |
| | messages via VAL server endpoint |
| | Redundant transport requirements for VAL server endpoint |
| | Caching policies for VAL server endpoint |
| | SEALDD measurement policies for VAL server endpoint |
| | Load balancing policies for VAL server endpoint |
| | Store-and-forward policies for VAL server endpoint |
| | Message aggregation policies for VAL server endpoint |
| | Message throttling policies for VAL server endpoint |
| | Message segmentation policies for VAL server endpoint |
| | Access control policies for the VAL server endpoint |
| | Subscription info from VAL server |
| | VAL client that the VAL server communicates with |
| | (if known) such as but not limited to the following: |
| | IP address of SEALDD client and VAL client |
| | Port(s) of SEALDD client and/or VAL client |
| | Transport protocol(s) of SEALDD client and/or VAL client |
| | Resource identifier(s) of SEALDD client and/or VAL client |
| | See Table 1 for additional description for each of the |
| | information elements mentioned above. |

Step 2: Upon receiving the SEALDD Service Subscription request, the SEALDD server may process the request by performing one or more of the following operations for each VAL server endpoint specified in the request:
1) discover an existing SEALDD flow in which the VAL server endpoint is specified as an endpoint (e.g., a SEALDD flow created or updated by a VAL client that comprises VAL server endpoint), or
2) if an existing SEALDD flow for the VAL endpoint is not discovered, create a new SEALDD flow. The SEALDD server may perform one or more of the operations defined in Step 2 of FIG. 6 using the VAL server endpoint information provided in the SEALDD Service Subscription request.

In addition to creating or updating SEALDD flow(s) and storing flow context locally on the SEALDD server, the SEALDD server may also create or update SEALDD flow context on one or more SEALD clients. For example, if information is provided in the SEALDD Service Subscription request for VAL client endpoint(s), the SEALDD server may trigger and/or perform the creation or update of SEALDD flow context on the SEALDD client(s) of the VAL client(s). When creating or updating SEALDD flow context on a SEALDD client, the SEALDD server may perform one or more of the operations defined in the aforementioned SEALDD flow context creation or update procedure using the VAL endpoint information provided in the SEALDD Service Subscription request.

Step 3: The SEALDD server may process the Service Subscription request, and the SEALDD server may return a response to the VAL server. If the processing is successful, the response may comprise a status indicating the SEALDD service subscription has been established and/or modified. The response may also comprise identifiers and/or representations of one or more SEALDD flows and their context information that the SEALDD server discovered or established for each of the VAL server endpoints. If the processing is not successful, the response may comprise information regarding the type of error encountered.

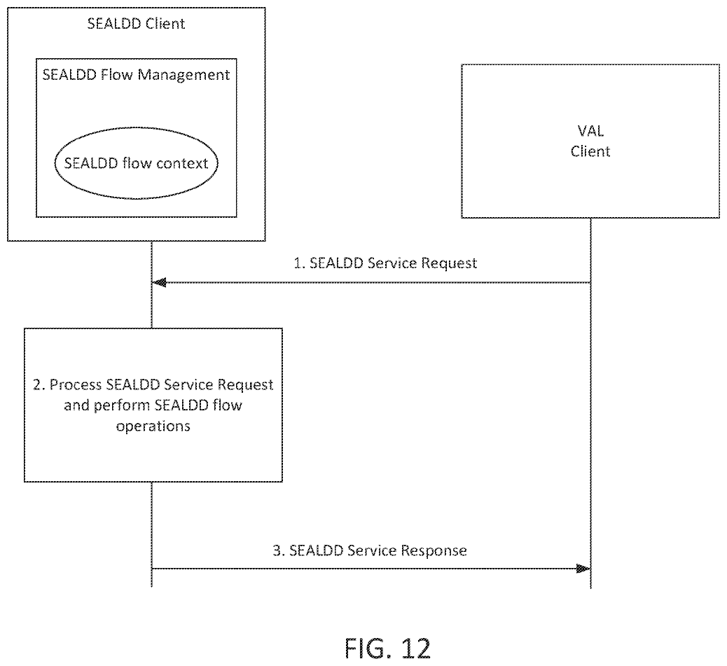

As shown in FIG. 12, an alternative to VAL clients initiating explicit requests to create, retrieve, update, delete and subscribe to SEALDD flows via SEALDD clients, is for SEALDD clients to perform one or more SEALDD flow management operations on behalf of VAL clients when SEALDD service requests are received and processed from VAL clients.

Step 1: VAL client issues a SEALDD service request to the SEALDD client that comprises one or more of the information elements defined in Table 13.

TABLE 13
SEALDD Service Request Information Elements

| Information Element | Description |
|---|---|
| List of VAL client | A VAL client may support one or more VAL client |
| endpoints | endpoints which the VAL client uses to send and/or receive |
| | VAL messages to and/or from VAL servers or other VAL |
| | clients. For each supported VAL client endpoint, one or |
| | more of the following information elements may be specified: |
| | Identifier of SEALDD flow associated with VAL |
| | endpoint (if known) |
| | IP address that is bound to VAL client endpoint |
| | IP port that is bound to VAL client endpoint |
| | Relative path that is bound to VAL client endpoint |
| | Scheduled availability for sending or receiving |
| | messages via VAL client endpoint |
| | Redundant transport requirements for VAL client endpoint |
| | Caching policies for VAL client endpoint |
| | SEALDD measurement policies for VAL client endpoint |
| | Load balancing policies for VAL client endpoint |
| | Store-and-forward policies for VAL client endpoint |
| | Message aggregation policies for VAL client endpoint |
| | Message throttling policies for VAL client endpoint |
| | Message segmentation policies for VAL client endpoint |
| | Access control policies for the VAL client endpoint |
| | Subscription info from VAL client |
| | VAL server(s) that the VAL client communicates |
| | with (if known) such as but not limited to the following: |
| | IP address of SEALDD server and VAL server |
| | Port(s) of SEALDD server and/or VAL server |
| | Transport protocol(s) of SEALDD server and/or VAL server |
| | Resource identifier(s) of SEALDD server and/or VAL server |
| | See Table 1 for additional description for each of the |
| | information elements mentioned above. |

Step 2: Upon receiving the SEALDD service request, the SEALDD client may process the request by performing one or more of the following operations for each VAL client endpoint specified in the request:
1) discover an existing SEALDD flow in which the VAL client endpoint is specified as a destination endpoint (e.g., a SEALDD flow established by a VAL server that comprises VAL client endpoint), or
2) if an existing SEALDD flow for the VAL endpoint is not discovered, create a new SEALDD flow. The SEALDD client may perform one or more of the operations defined in Step 2 of FIG. 6 using the VAL client endpoint information provided in the SEALDD service request.

In addition to creating or updating SEALDD flow(s) and storing flow context locally on the SEALDD client, the SEALDD client may also create or update SEALDD flow context on one or more SEALD servers. For example, if information is provided in the SEALDD service request for VAL server endpoint(s), the SEALDD client may trigger and/or perform the creation or update of SEALDD flow context on the SEALDD server(s) of the VAL server(s). When creating or updating SEALDD flow context on a SEALDD server, the SEALDD client may perform one or more of the operations defined in the aforementioned SEALDD flow context creation or update procedure using the VAL endpoint information provided in the SEALDD service request.

Step 3: The SEALDD client may process the service request, and the SEALDD client may return a response to the VAL client. If the processing is successful, the response may comprise a status indicating the SEALDD service request has been processed. The response may also comprise identifiers and/or representations of one or more SEALDD flows and their context information that the SEALDD client discovered or established for each of the VAL client endpoints. If the processing is not successful, the response may comprise information regarding the type of error encountered.

Systems and methods are proposed herein for service enabler data delivery flow management. For example, the method described in FIG. 12 may comprise receiving, by a first service enabler architecture layer for data delivery (SEALDD) server and from a SEALDD client, a request to establish a SEALDD flow, wherein the SEALDD flow facilitates a transfer of vertical application layer (VAL) data between a VAL client endpoint and a first VAL server endpoint, and wherein the request comprises at least one of VAL client endpoint information and first VAL server endpoint information. The method may further comprise processing, by the first SEALDD server, the request by establishing a SEALDD flow associated with the first VAL server and associated with at least one VAL client endpoint specified in the request. The method may further comprise subscribing, by the first SEALDD server, to a core network. The method may further comprise receiving, by the first SEALDD server and based on the subscribing to the core network, a notification from the core network indicating a user equipment (UE) mobility event associated with a UE upon which the VAL client is hosted. The method may further comprise determining to transfer the VAL client to a second VAL server based on the mobility event. The method may further comprise transferring, by the first SEALDD server, the SEALDD flow to a second SEALDD server associated with the second VAL server.

The method described in FIG. 12 may further comprise a SEALDD flow identifier assigned by the SEALDD client.

The method described in FIG. 12 may further comprise wherein the VAL client endpoint information and the VAL server endpoint information further comprise at least one of a VAL client identifier, an internet protocol (IP) address, a port, or a uniform resource locator (URL).

The method described in FIG. 12 may further comprise wherein transferring the SEALDD flow to the second SEALDD server further comprises the first SEALDD server sending a request to push SEALDD flow information to the second SEALDD server.

The method described in FIG. 12 may further comprise wherein transferring the SEALDD flow to the second SEALDD server further comprises the second SEALDD server sending a request to pull SEALDD flow information from the first SEALDD server.

The method described in FIG. 12 may further comprise wherein transferring the SEALDD flow to the second SEALDD server further comprises sending, by the first SEALDD server, a SEALDD flow identifier to the second SEALDD server.

The method described in FIG. 12 may further comprise sending a response to the SEALDD client comprising an indication of successful establishment of the SEALDD flow.

The method described in FIG. 12 may further comprise sending a response to the SEALDD client comprising at least one of a first SEALDD server IP address or a first SEALDD server uniform resource identifier (URI).

For example, the system described in FIG. 12 may comprise a first service enabler architecture layer for data delivery (SEALDD) server apparatus. The SEALDD server apparatus may be configured to receive, from a SEALDD client, a request to establish a SEALDD flow, wherein the SEALDD flow facilitates a transfer of vertical application layer (VAL) data between a VAL client endpoint and a first VAL server endpoint, and wherein the request comprises at least one of VAL client endpoint information and first VAL server endpoint information. The SEALDD server apparatus may be further configured to process the request by establishing a SEALDD flow associated with the first VAL server and associated with at least one VAL client endpoint specified in the request. The SEALDD server apparatus may be further configured to subscribe to a core network. The SEALDD server apparatus may be further configured to receive, based on the subscribing to the core network, a notification from the core network indicating a user equipment (UE) mobility event associated with a UE upon which the VAL client is hosted. The SEALDD server apparatus may be further configured to determine to transfer the VAL client to a second VAL server based on the mobility event. The SEALDD server apparatus may be further configured to transfer the SEALDD flow to a second SEALDD server associated with the second VAL server.

The SEALDD server apparatus described in FIG. 12 may further comprise a SEALDD flow identifier assigned by the SEALDD client.

The SEALDD server apparatus described in FIG. 12 may further comprise wherein the VAL client endpoint information and the VAL server endpoint information further comprise at least one of a VAL client identifier, an internet protocol (IP) address, a port, or a uniform resource locator (URL).

The SEALDD server apparatus described in FIG. 12 configured to cause the apparatus to transfer the SEALDD flow to the second SEALDD server may further comprise causing the apparatus to send a request to push SEALDD flow information to the second SEALDD server.

The SEALDD server apparatus described in FIG. 12 configured to cause the apparatus to transfer the SEALDD flow to the second SEALDD server may further comprise the second SEALDD server sending a request to pull SEALDD flow information from the apparatus.

The SEALDD server apparatus described in FIG. 12 configured to cause the apparatus to transfer the SEALDD flow to the second SEALDD server may further comprise causing the apparatus to send a SEALDD flow identifier to the second SEALDD server.

The SEALDD server apparatus described in FIG. 12 may further comprise causing the first SEALDD server apparatus to send a response to the SEALDD client comprising an indication of successful establishment of the SEALDD flow.

The SEALDD server apparatus described in FIG. 12 may further comprise causing the first SEALDD server apparatus to send a response to the SEALDD client comprising at least one of a first SEALDD server apparatus IP address or a first SEALDD server apparatus uniform resource identifier (URI).

For example, the method described in FIG. 12 may comprise sending, by a service enabler architecture layer for data delivery (SEALDD) client and to a first SEALDD server, a request to establish a SEALDD flow, wherein the SEALDD flow facilitates a transfer of vertical application layer (VAL) data between a VAL client endpoint and a VAL server endpoint, and wherein the request comprises at least one of VAL client endpoint information and VAL server endpoint information. The method may further comprise receiving an indication of an establishment of a SEALDD flow associated with the VAL server and with at least one VAL client endpoint specified in the request. The method may further comprise determining occurrence of a user equipment (UE) mobility event of a UE upon which the VAL client is hosted. The method may further comprise receiving, from the first SEALDD server, a transfer of the SEALDD flow to a second SEALDD server associated with the VAL server.

The method described in FIG. 12 may further comprise a SEALDD flow identifier assigned by the SEALDD client.

The method described in FIG. 12 may further comprise wherein the VAL client endpoint information and the VAL server endpoint information further comprise at least one of a VAL client identifier, an internet protocol (IP) address, a port, or a uniform resource locator (URL).

The method described in FIG. 12 may further comprise receiving, from the first SEALDD server, at least one of an indication of successful establishment of the SEALDD flow, a first SEALDD server IP address, or a first SEALDD server uniform resource identifier (URI).

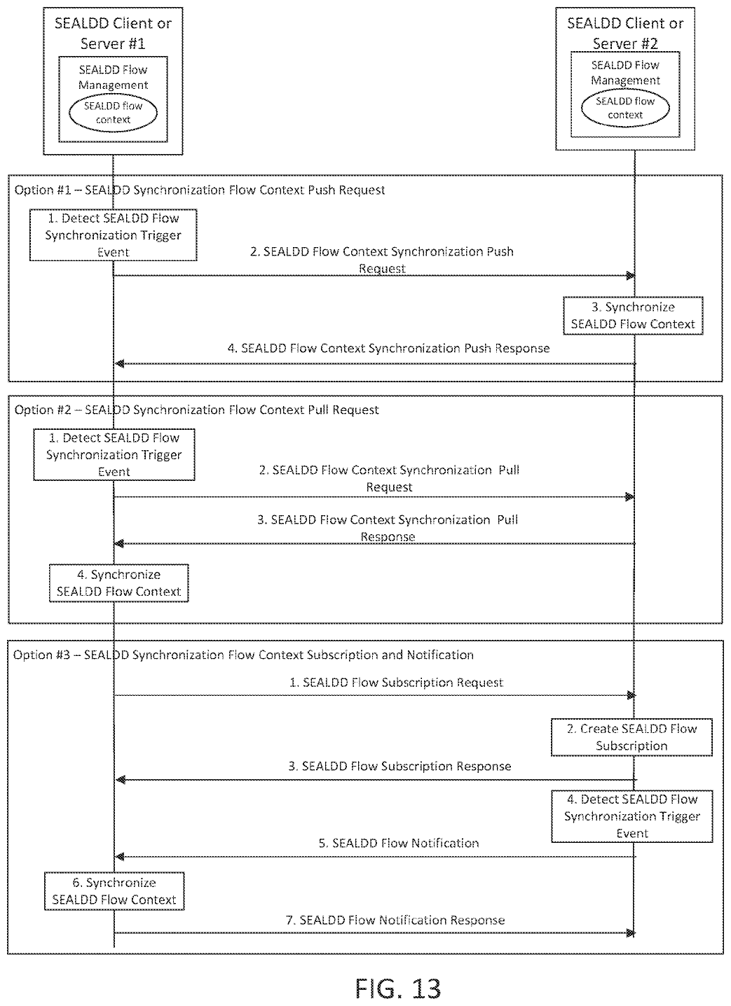

SEALDD clients and servers may synchronize SEALDD flow context with other SEALDD clients and servers such that their flow context remains consistent with one another. Detection of various types of events may result in the SEALDD clients and servers triggering the exchange of SEALDD flow context with each other. Several SEALDD flow synchronization options are proposed as shown in FIG. 13.

### Option #1—SEALDD Synchronization Flow Context Push Request

Step 1: SEALDD client or server #1detects a SEALDD flow synchronization trigger event such as but not limited to the following:
1) The creation of a new SEALDD flow and context
2) The update of one or more SEALDD flow context information elements such as:
2a) one or more source or destination endpoints in the flow changing
2b) the status of the flow changing from enabled to disabled or vice versa
2c) changes to the quantity, status, or configuration of one or more of the redundant transports of the flow
2d) changes to the caching policies of the flow
2e) new VAL response messages being cached for the flow
2f) changes to the measurement policies of the flow
2g) new measurements being collected for the flow
2h) changes to load balancing policies for the flow
2i) changes to store-and-forward policies for the flow
2j) changes to message aggregation, throttling or segmentation policies for the flow
2k) changes to access control policies for the flow
2l) changes to subscriptions for the flow

Step 2: SEALDD client or server #1 sends a SEALDD flow synchronization push request to SEALDD client or server #2. The request comprises SEALDD flow context information such as one or more elements defined in Table 1.

Step 3: SEALDD client or server #2 receives and processes the SEALDD flow synchronization push request by updating its local SEALDD flow context with the information incorporated with the request.

Step 4: SEALDD client or server #2 returns a response to SEALDD client or server #1 comprising an indication that the synchronization has been performed. Within the response SEALDD client or server #2 may comprise the one or more elements of SEALDD flow context information that have been updated by the request.

### Option #2—SEALDD Synchronization Flow Context Pull Request

SEALDD client or server #1 detects a SEALDD flow synchronization trigger event such as but not limited to the following:
1) receiving a request to retrieve or discover a SEALDD flow
2) receiving a request to send or receive a VAL message via a SEALDD flow
3) receiving a request to retrieve measurements of a SEALDD flow

Step 2: SEALDD client or server #1 sends a SEALDD flow synchronization pull request to SEALDD client or server #2. The request comprises SEALDD flow context information defined in Table 1 which identify the relevant SEALDD flows. For example, an identifier and/or address of the SEALDD flow context stored on SEALDD client or server #2. The request may also comprise filter criteria. The filter criteria may be formatted based on the criteria defined in Table 4.

Step 3: SEALDD client or server #2 receives and processes the SEALDD flow synchronization pull request by gathering the relevant SEALDD flow context information pertaining to the request and that meet the filter criteria (if any) specified in the request.

Step 4: SEALDD client or server #1 updates it's SEALDD flow context information with the information comprised in the response.

### Option #3—SEALDD Synchronization Flow Context Subscription and Notification

Step 1: SEALDD client or server #1 sends a SEALDD flow subscription request to SEALDD client or server #2. The request may comprise one or more information elements defined in Table 8.

Step 2: SEALDD client or server #2 receives the SEALDD flow subscription request and processes as defined in Step 2 of the aforementioned SEALDD flow subscription procedure.

Step 3: SEALDD client or server #2 returns a SEALDD flow subscription response as defined in Step 3 of the aforementioned SEALDD flow subscription procedure.

Step 4: SEALDD client or server #2 detects that the notification criteria defined within the SEALDD flow subscription have been met.

Step 5: SEALDD client or server #2 generates a SEALDD notification that comprises SEALDD flow context information. The notification may also comprise additional information elements such as those defined in Table 10.

Step 6: SEALDD client or server #1 updates it's SEALDD flow context information with the information comprised in the response.

Step 7: SEALD client or server #1 may generate and return a SEALDD flow notification response. Where the notification response may comprise one or more of the information elements defined in Table 11.

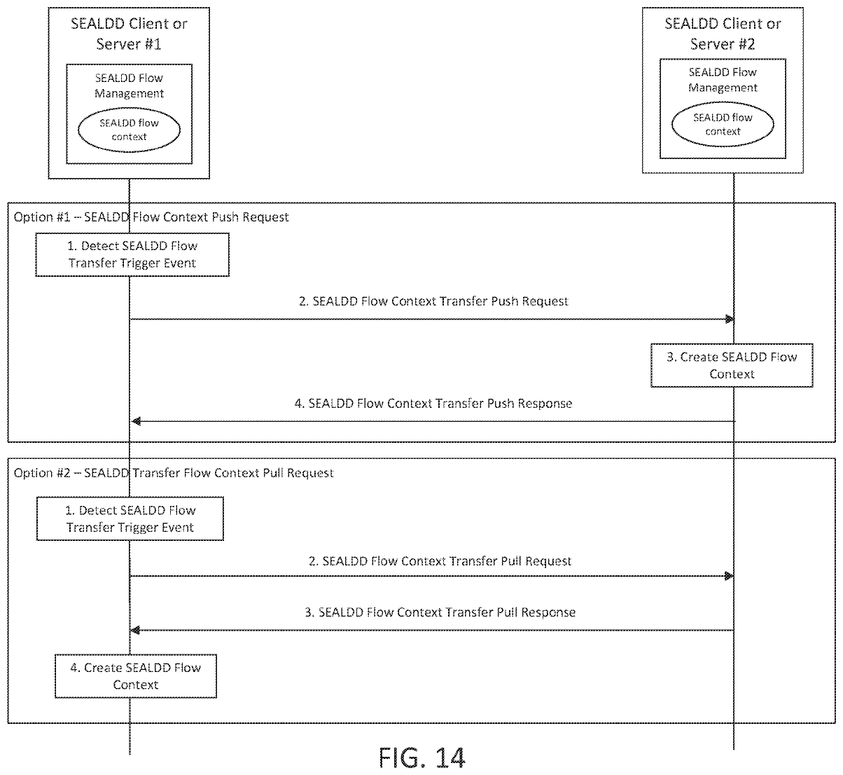

SEALDD clients and servers may transfer SEALDD flow context to other SEALDD clients and servers. The transfer may take place for different use case scenarios, for example a UE moves to a new location in the network which requires a VAL client to transition over to using a different VAL server which uses a different SEALDD server. For these types of use cases, it may be beneficial to transfer SEALDD flow context between SEALDD clients and/or servers to optimize and maintain continuity of service. The transfer of SEALDD flow context may take place when various types of events are detected resulting in the SEALDD clients and servers triggering the exchange of SEALDD flow context with each other. Several SEALDD flow context transfer options are proposed as shown in FIG. 14.

### Option #1—SEALDD Transfer Flow Context Push Request

Step 1: SEALDD client or server #1 detects a SEALDD flow transfer trigger event such as but not limited to the following:
1) An indication from a VAL client that the VAL client is transitioning over to using a different VAL server associated with a different SEALDD server
2) An indication from a VAL server that a VAL client is transitioning over to using a different VAL server associated with a different SEALDD server
3) An indication from a function in the network (e.g., EES or ECS) that a service continuity operation requires a SEALDD flow to be transitioned to a different SEALDD server
4) An indication from a function in the underlying network (e.g., NEF) indicating that a UE hosting a SEALDD client is no longer located in the service area of a SEALDD server and requires transitioning to a different SEALDD server located in the UE's new location.

Step 2: SEALDD client or server #1 sends a SEALDD flow transfer push request to SEALDD client or server #2. The request comprises SEALDD flow context information such as one or more elements defined in Table 1.

Step 3: SEALDD client or server #2 receives and processes the SEALDD flow transfer push request by creating and storing the SEALDD flow context comprised in the request. SEALDD client or server #2 may perform additional SEALDD flow related operations such as establishing one or more underlying transports and/or start collecting one or more SEALDD flow related measurements. SEALDD client or server #2 may also update select elements within the flow context to reflect the transfer of the SEALDD flow to SEALDD client or server #2. For example, the values of any IP addresses, ports, transport protocols and resource identifiers comprised within the SEALDD flow context information elements may be updated to reflect configuration or settings of SEALDD client or server #2.

Step 4: SEALDD client or server #2 returns a response to SEALDD client or server #1 comprising an indication that the transfer has been performed. Within the response SEALDD client or server #2 may comprise the one or more elements of SEALDD flow context information that have been updated during the transfer.

### Option #2—SEALDD Transfer Flow Context Pull Request

Step 1: SEALDD client or server #1 detects a SEALDD flow transfer trigger event such as but not limited to those specified in Option #1 Step 1.

Step 2: SEALDD client or server #1 sends a SEALDD flow transfer pull request to SEALDD client or server #2. The request comprises SEALDD flow context information defined in Table 1 which identify the relevant SEALDD flows. For example, an identifier and/or address of the SEALDD flow context stored on SEALDD client or server #2. The request may also comprise filter criteria. The filter criteria may be formatted based on the criteria defined in Table 4.

Step 3: SEALDD client or server #2 receives and processes the SEALDD flow transfer pull request by gathering the relevant SEALDD flow context information pertaining to the request and that meet the filter criteria (if any) specified in the request and sending this information to SEALDD client or server #1 in the response.

Step 4: SEALDD client or server #1 receives and processes the SEALDD flow transfer response request by creating and storing the SEALDD flow context incorporated in the response. SEALDD client or server #2 may perform additional SEALDD flow related operations such as establishing one or more underlying transports and/or start collecting one or more SEALDD flow related measurements. SEALDD client or server #1 may also update select elements within the flow context to reflect the transfer of the SEALDD flow to SEALDD client or server #1. For example, the values of any IP addresses, ports, transport protocols and resource identifiers comprised within the SEALDD flow context information elements may be updated to reflect configuration or settings of SEALDD client or server #1.

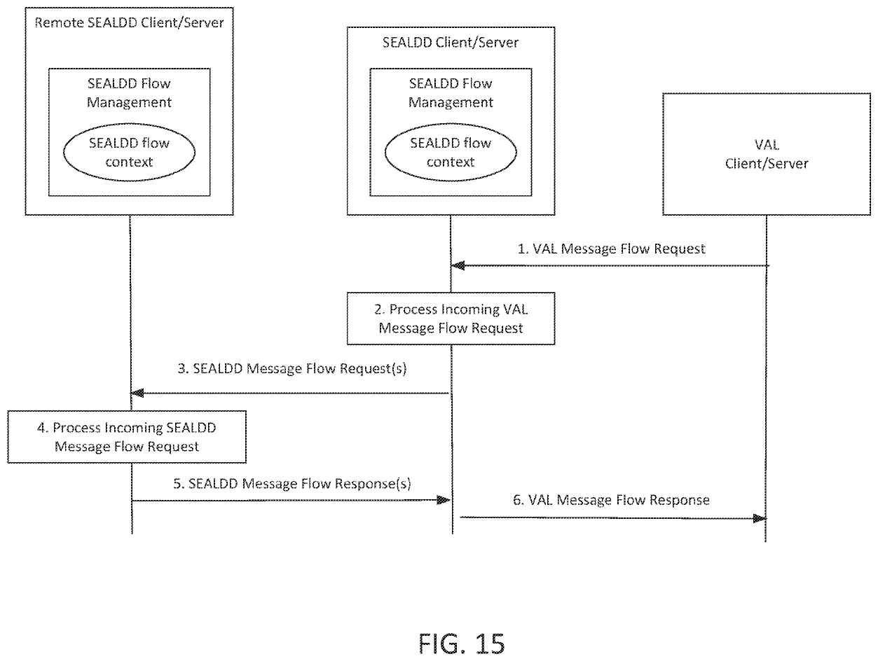

As shown in FIG. 15, VAL clients or servers may initiate a request to send a VAL message via a SEALDD flow.

Step 1: A VAL client or server issues a request to transmit a VAL message to a remote VAL client or server via an established SEALDD flow. The request may comprise one or more of the information elements defined in Table 14.

Note, a VAL client or server may also issue a request to transmit a VAL message via SEALDD before a SEALDD flow has been established. In this case, the SEALDD client or server receiving the request may establish a SEALDD flow on behalf of the VAL client or server. The SEALDD client or server may rely on some default configuration or policies if the VAL client or server does not provide adequate SEALDD flow context information.

Alternatively, VAL message transmission may be triggered by other VAL message flow requests providing the necessary information, e.g. MSGin5G message request. The SEALDD client or server may translate such requests into SEALDD message flow requests based on the parameters of the request, as well as on pre-configured information such as SEALDD local policies, VAL server or VAL client specific policies, contextual information, etc.

TABLE 14
SEALDD Flow-based VAL Message Request Information Elements

| Information Element | Description |
|---|---|
| SEALDD Message ID | Unique ID of the SEALDD message |
| SEALDD flow ID | ID of the SEALDD flow (see Table 1) associated with the request |
| SEALDD flow | The SEALDD client or server address associated with this |
| message entry point | SEALDD client or server for which the source VAL client or server |
| | endpoint(s) may target messages towards for this flow (See Table 1). |
| VAL message source | ID or address of the VAL client or server endpoint initiating |
| endpoint | the request (e.g., IP address and port, FQDN, URI, etc.) |
| VAL message | ID or address of the remote VAL client or server endpoint targeted by |
| destination endpoint | the request (e.g., IP address and port, FQDN, URI, etc.) |
| VAL message payload | Contents of the VAL message payload |

Step 2: Upon receiving the request, the targeted SEALDD client or server determines if the request is associated with a SEALDD flow. The SEALDD client server may make this determination by checking whether the SEALDD flow ID specified in the request matches a SEALDD flow ID for an established SEALDD flow. Alternatively, this check may be made by checking the SEALDD flow message entry point configured in the message matches a flow entry point (e.g., IP address and port and/or URI) for which the SEALDD client or server is configured to receive VAL requests for a given SEALDD flow. These checks may be performed by the SEALDD client or server using SEALDD flow context stored locally by the SEALDD client server or stored remotely by another SEALDD client or server which the SEALDD client or server retrieves.

If the request is found to be associated with a valid SEALDD flow, the SEALDD client or server may perform one or more of the following operations based on information in the received request and the SEALDD flow context information:
1) The SEALDD client or server may check whether the VAL client or server originating the request has permissions to transmit VAL messages via the SEALDD flow. The check may be performed by the SEALDD client or server checking the source VAL client or server ID specified in the request against the access control policies of the SEALDD flow context to determine if the VAL client or server has the necessary permissions. If allowed, the SEALDD client or server processes the request, otherwise the request may be rejected.
2) Determine if the VAL message comprised in the request requires forwarding to a remote SEALDD client or server by checking the VAL destination endpoint information in the request and/or VAL destination endpoint information stored within the SEALDD flow context information. The SEALDD client or server may also check whether the VAL message is a request and if so whether the SEALDD client or server has a cached VAL response that the SEALDD client or server may use to respond to the VAL request message. If so, the SEALDD client or server may process the VAL request message locally using the cached VAL response message. In this case the SEALDD client or server may not need to forward the VAL message to a remote VAL client or server for processing. Otherwise, if the VAL message requires forwarding, the SEALDD client or server prepares a SEALDD message by encapsulating the VAL message within the payload of the SEALDD message. The SEALDD client or server also generates and appends a SEALDD header onto the message which may comprise one or more of the following elements:
2a) SEALDD message ID which the SEALDD client or server generates
2b) SEALDD message segment ID (if segmenting of VAL message is required)
2c) Flow ID
2d) VAL source endpoint
2e) VAL destination endpoint
2f) ID of the SEALDD client or server that received the request
2g) Network address (e.g., IP address, port, URI, etc.) of the remote SEALDD client or server used to receive and process SEALDD messages.
3) Note that when formatting or encapsulating the payload to generate the message to be transmitted, the SEALDD client or server may also determine transport-level characteristics of the delivery method or technology (e.g. NIDD), channel, bearer, etc. which needs to be established. The transport-level determination may also be based on pre-configured information such as SEALDD local policies, VAL server or VAL client specific policies, UE subscription information, as well as contextual information (location, time of day, network status, etc.). Alternatively, within this step, the SEALDD server may also determine whether a specific delivery mechanism (e.g. MSGin5G messaging) should be used for delivery of the payload to the client on the UE.
4) Determine if the request requires redundant transports for sending to the remote SEALDD client or server by checking whether the redundant transport requirements and status are configured within the SEALDD flow context. If redundant transports are required but the redundant transports have not yet been established, the SEALDD client or server may trigger the establishment of the redundant transports between the flow context of the SEALDD client or server and the remote SEALDD flow context(s) hosted on the remote SEALDD client(s) or server(s). The SEALDD client or server may also update the SEALDD flow context's redundant transport status to reflect whether or not redundant transports have been established or not.
5) Determine if the request requires store-and-forward buffering and scheduling before sending the request to the remote SEALDD client or server by checking whether a store-and-forward policies are configured in the SEALDD flow context. If yes, the SEALDD client or server may check whether the configured policies permit forwarding the request to the remote SEALDD client or server at this time or requires buffering to be sent at a later time as specified by information in the policies (e.g., scheduled forwarding time windows). If buffering is required, the SEALDD client or server may buffer the request and send the request at the later time.
6) Aggregate VAL messages if the request requires aggregation before sending the request to the remote SEALDD client or server by checking whether message aggregation policies are configured in the SEALDD flow context. If yes, the SEALDD client or server may aggregate the received VAL message along with other VAL messages that are received within a time window that is defined by the message aggregation policy.
7) Throttle VAL messages if the request requires throttling before sending the request to the remote SEALDD client or server by checking whether a message throttling policy is configured for the flow and whether the maximum message rate or quantity of bytes for the flow has been exceeded. This check may be performed by the SEALDD client or server checking limits configured in the SEALDD flow context or a local policy of the SEALDD client or server. If the limits have been exceeded, SEALDD client or server may throttle the received message by either buffering and delaying the forwarding of the message to the remote SEALDD client or server or rejecting the received message.
8) Segment VAL messages if the request requires segmentation before sending the request to the remote SEALDD client or server by checking whether the received message exceeds a maximum message size. This check may be performed by the SEALDD client or server checking a maximum message size configured in a message segmentation policy defined within the SEALDD flow context or a local policy of the SEALDD client or server. If the maximum message size has been exceeded, SEALDD client or server may segment the received message into multiple SEALDD messages which are sent individually to the remote SEALDD client or server. Within each segmented message, the SEALDD client or server may comprise a message segment identifier defining an association and order between the segmented messages.
9) Collect measurements if processing of the message requires measurements to be collected by the SEALDD client or server. This determination may be made by the SEALDD client or server checking the measurement policies (if any) configured in the SEALDD flow context. For example, measurements may be collected if the measurement policies specify that VAL message transport measurements (e.g., average reliability, latency and throughput for messages processed via flow), VAL message load balancing measurements for flow (e.g., quantity of requests forwarded to each VAL or SEALDD server of flow), VAL message store-and-forward measurements (e.g., quantity of requests stored, average store time before forwarding requests of flow), VAL message aggregation measurements (e.g., quantity of requests aggregated (in total, on average) are to be collected for the flow by the SEALDD client or server.

Step 3: The SEALDD client or server sends the SEALDD request message(s) to the remote SEALDD client or server flow context. The sending of the SEALDD request message(s) may involve the SEALDD client or server sending the requests over multiple redundant transports.

Step 4: The remote SEALDD client or server receives and processes the SEALDD request message. The reception of the SEALDD request message(s) may involve the SEALDD client or server receiving the requests over multiple redundant transports. Using the SEALDD message IDs and/or flow IDs within SEALDD messages sent over the redundant transports, the remote SEALDD client or server may filter duplicate SEALDD messages before further processing. The further processing may comprise one or more of the following operations:
1) Upon receiving the request, the remote SEALDD client or server determines if the request is associated with a SEALDD flow. The remote SEALDD client server may make this determination by checking whether the SEALDD flow ID specified in the request matches a SEALDD flow ID for an established SEALDD flow. This check may be performed by the remote SEALDD client or server using SEALDD flow context stored locally by the remote SEALDD client server or stored by another SEALDD client or server which the remote SEALDD client or server retrieves. If the request is found to be associated with a valid SEALDD flow, the remote SEALDD client or server may process the request, otherwise the SEALDD client or server may return an error.
2) The remote SEALDD client or server may check whether the SEALDD client or server originating the request has permissions to transmit SEALDD messages via the SEALDD flow. The remote SEALDD client or server may also check whether the source VAL endpoint has permissions to transmit VAL messages to the destination VAL endpoint. These checks may be performed by the remote SEALDD client or server checking the SEALLDD client or server ID and/or source VAL endpoint ID specified in the request against the access control policies of the SEALDD flow context to determine if the necessary permissions exist. If allowed, the remote SEALDD client or server processes the request, otherwise the request may be rejected.
3) Extract the VAL message(s) encapsulated within the SEALDD message. If VAL messages were segmented and sent across multiple SEALDD messages, the remote SEALDD client or server reassembles the segmented VAL messages. This reassembly may leverage a SEALDD message segment ID present within each of the SEALDD messages to detect which VAL message segments need to be reassembled with one another and their reassembly order. If multiple VAL messages are aggregated into a single SEALDD message, the remote SEALDD client or server may separate these VAL messages during the VAL message extraction process.
4) For each VAL message extracted from the SEALDD message(s), the remote SEALDD client or server determines if the VAL message requires forwarding to a destination VAL client or server. This determination is made by checking if a destination VAL client or server endpoint is specified in the request. If forwarding is required, the remote SEALDD client or server forwards the VAL message accordingly.

Step 5: The remote SEALDD client or server may return SEALDD response message(s) to the SEALDD client or server. The sending of the SEALDD response message(s) may involve the remote SEALDD client or server sending the response over multiple redundant transports. The responses may comprise one or more of the following elements:
1) Same SEALDD message ID that was incorporated in the SEALDD request message
2) Same message segment ID that was incorporated in the SEALDD request message
3) Flow ID
4) ID of the remote SEALDD client or server that received the request
5) Network address of the SEALDD client or server that originated the SEALDD request
6) a status indication acknowledging whether the request was received and processed successfully

Preparation and sending of the SEALDD response by the remote SEALDD client or server may comprise one or more of the following operations:
1) Determine if the response requires redundant transports when the response is sent to the SEALDD client or server by checking whether the redundant transport requirements and status are configured within the SEALDD flow context. If redundant transports are required but the redundant transports have not yet been established, the remote SEALDD client or server may trigger the establishment of the redundant transports between the remote SEALDD client or server and the SEALDD flow context(s). The remote SEALDD client or server may also update the SEALDD flow context's redundant transport status to reflect whether or not redundant transports have been established or not.
2) Determine if the response requires store-and-forward buffering and scheduling before sending the response to the SEALDD client or server by checking whether a store-and-forward policies are configured in the SEALDD flow context. If yes, the remote SEALDD client or server may check whether the configured policies permit forwarding the response to the SEALDD client or server at this time or requires buffering to be sent at a later time as specified by information in the policies (e.g., scheduled forwarding time windows). If buffering is required, the remote SEALDD client or server may buffer the response and send the response at the later time.
3) Determine if the response requires aggregation before sending the response to the SEALDD client or server by checking whether message aggregation policies are configured in the SEALDD flow context. If yes, the remote SEALDD client or server may aggregate the response along with other responses within a time window that is defined by the message aggregation policy.
4) Determine if the response requires throttling before sending the response to the SEALDD client or server by checking whether a message throttling policy is configured for the flow and whether the maximum message rate or quantity of bytes for the flow has been exceeded. This check may be performed by the remote SEALDD client or server checking limits configured in the SEALDD flow context or a local policy of the remote SEALDD client or server. If the limits have been exceeded, the remote SEALDD client or server may throttle the response by either buffering and delaying the forwarding of the response to the SEALDD client or server.
5) Determine if response handling requires measurements to be collected by the remote SEALDD client or server by checking the measurement policies (if any) configured in the SEALDD flow context. For example, measurements may be collected if the measurement policies specify that VAL message transport measurements (e.g., average reliability, latency and throughput for messages processed via flow), VAL message load balancing measurements for flow (e.g., quantity of requests forwarded to each VAL or SEALDD server of flow), VAL message store-and-forward measurements (e.g., quantity of requests stored, average store time before forwarding requests of flow), VAL message aggregation measurements (e.g., quantity of requests aggregated (in total, on average) are to be collected for the flow by the remote SEALDD client or server.

Step 6: The SEALDD client or server may send a VAL response message to the VAL client or server that originated the request. The SEALDD client or server may generate the VAL response message at least one of before or after forwarding the request(s) to the remote SEALDD client or server flow context and/or receiving one or more responses back. The SEALDD client or server may qualify the contents of the response based on one or more response(s) received from the remote SEALDD client or server. The response may comprise a status indication of whether the VAL request message was successfully processed or not.

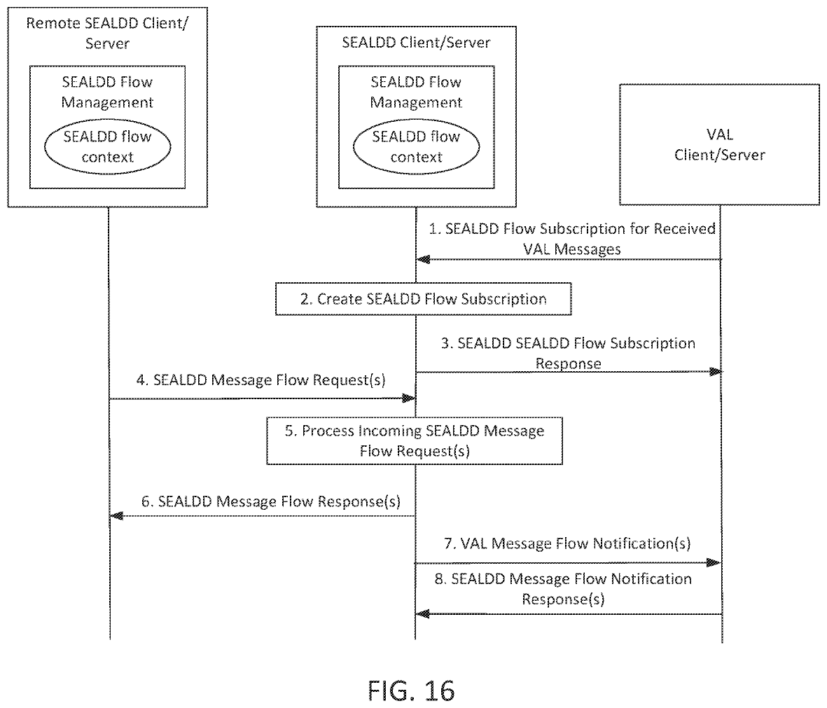

As shown in FIG. 16, VAL clients or servers may initiate subscriptions to receive VAL messages via a SEALDD flow. Alternatively, SEALDD clients or servers may forward VAL messages to a VAL client or server using information provided in the request or stored within the SEALDD flow context.

Step 1: A VAL client or server issues a SEALDD flow subscription request to a SEALDD client or server to receive notifications if VAL messages are received by the SEALDD client or server which target the VAL client or server. The request may comprise information elements such as but not limited to those proposed in Table 8. The notification criteria may be configured such that notifications are generated for each VAL message that is received by the SEALDD client or server and which targets the VAL client or server.

Step 2: The SEALDD client or server creates and stores the SEALDD flow subscription on the SEALDD client or server. The SEALDD client or server may begin monitoring to detect if VAL messages are received via the corresponding SEALDD flow which target the VAL client or server.

Step 3: The SEALDD client or server returns a response to the VAL client or server indicating whether the SEALDD flow subscription request was successfully processed or not.

Step 4: The SEALDD client or server receives SEALDD message(s) from a remote SEALDD client or server, where the message(s) are associated with the SEALDD flow that the VAL client or server has subscribed to. Note that the reception of SEALDD messages by a remote SEALDD client or server may be enabled at the remote device via pre-configuration, instead of the execution of steps 1-3 above. Alternatively, the step 4 SEALDD message flow request in step 4 may provide the necessary information such that steps 5-8 may be executed without steps 1-3.

Step 5: The SEALDD client or server processes the received SEALDD message(s) and extracts the VAL messages(s) encapsulated within the payload of these SEALDD message(s).

In connection with the SEALDD client or server processing the received SEALDD message, the SEALDD client or server may determine that another application-level delivery mechanism (e.g. MSGijn5G) should be used for delivery of the payload to the VAL client or server. The determination may be done based on the received message parameters or on transport-level characteristics or the delivery method or technology (e.g. NIDD) of the incoming message. The determination may also be based on pre-configured information such as SEALDD local policies, VAL server or client specific policies, UE subscription information, as well as contextual information (location, time of day, network status, etc.).

Step 6: The SEALDD client or server returns response(s) to the remote SEALDD client or server for the received SEALDD message(s). The responses indicate whether the SEALDD messages were successfully received or not.

Step 7: For each extracted VAL message, the SEALDD client or server checks if the destination VAL endpoint matches the VAL client or server that subscribed to the SEALDD client or server in Step 1. If a match occurs, the SEALDD client or server sends a SEALDD flow notification to the SEALDD client or server. The VAL message is incorporated within the notification as proposed in Table 9.

Step 8: The VAL client or server may respond back to the SEALDD client or server indicating that the VAL message was successfully received.

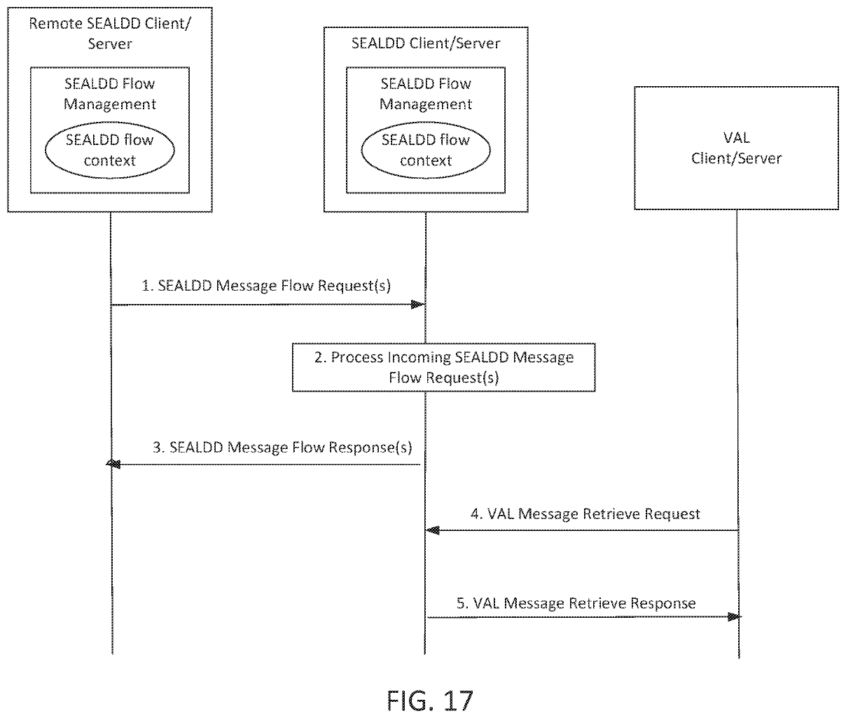

As shown in FIG. 17, an alternative to using subscriptions to receive VAL messages from a SEALDD client or server via notifications, a VAL client or server may instead retrieve the messages from the SEALDD client or server. For example, a VAL client or server may periodically poll a SEALDD client or server to fetch VAL messages. Until VAL messages are retrieved from a SEALDD client or server, the SEALDD client or server may buffer any VAL messages it receives which target the VAL client or server.

Step 1: The SEALDD client or server receives SEALDD message(s) from a remote SEALDD client or server, where the message(s) are associated with the SEALDD flow that the VAL client or server receives VAL messages from.

Step 2: The SEALDD client or server processes the received SEALDD message(s) and extracts the VAL messages(s) encapsulated within the payload of these SEALDD message(s). For each extracted VAL message, the SEALDD client or server checks if the destination VAL endpoint matches a VAL client or server configured within the SEALDD flow context. If a match occurs, the SEALDD client or server buffers the VAL message.

Step 3: The SEALDD client or server returns response(s) to the remote SEALDD client or server for the received SEALDD message(s). The responses indicate whether the SEALDD messages were successfully received or not.

Step 4: The VAL client or server issues a SEALDD flow retrieval request to the SEALDD client or server to check if there are any VAL messages that have been received for the VAL client or server. The retrieval request may comprise one or more of the information elements defined in Table 4. The request is targeted towards a SEALDD client or server address (e.g., IP address and port and/or URI) that supports receiving VAL client or server requests to retrieve VAL messages received via a SEALDD flow. For example, a SEALDD flow message exit point as defined in Table 1.

Step 5: Upon receiving the retrieval request, the SEALDD client or server checks if any received VAL messages are buffered for the VAL client and server. If yes, the SEALDD client or server forwards the VAL messages to the VAL client or server within the SEALDD flow retrieval response that it returns.

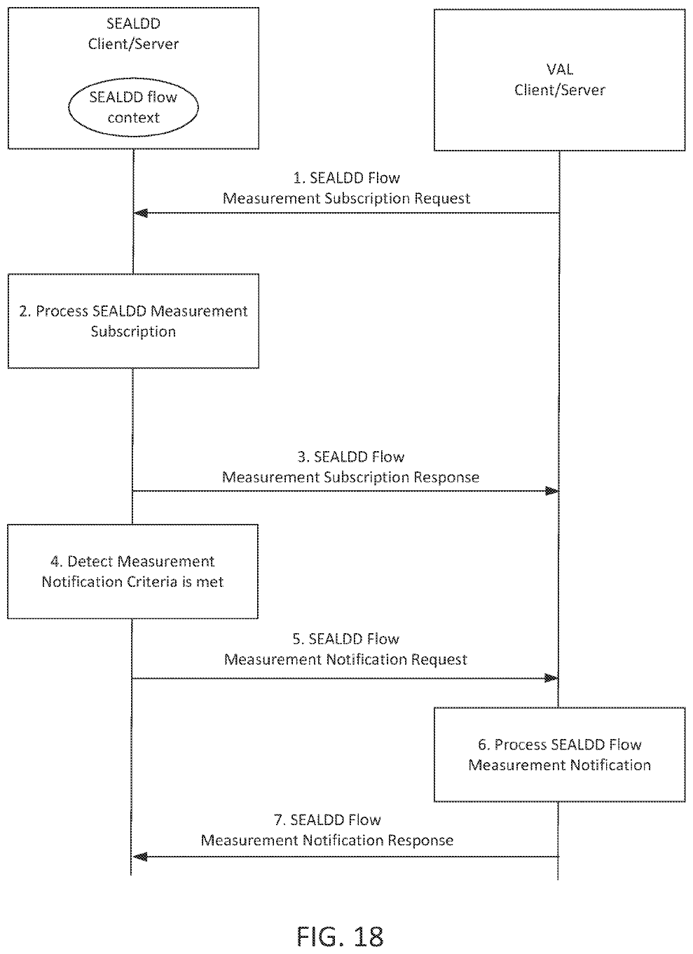

As shown in FIG. 18, VAL clients or servers may initiate subscriptions to receive SEALDD measurements via a SEALDD flow. Alternatively, a measurement subscription request may be embedded within a SEALDD flow creation request.

Step 1: A VAL client or server issues a SEALDD flow subscription request to a SEALDD client or server to receive notifications if SEALDD measurements are generated by the SEALDD client or server. The request may comprise information elements such as but not limited to those proposed in Table 8. The notification criteria may be configured such that notifications are generated for one or more SEALDD types of measurements of interest to the VAL client or server or if a value of a specified measurement matches a specified criteria (e.g., crosses a specified threshold value of interest).

Step 2: The SEALDD client or server creates and stores the SEALDD flow subscription on the SEALDD client or server. The SEALDD client or server may begin monitoring to detect if SEALDD measurements matching the specified criteria are generated.

Step 3: The SEALDD client or server returns a response to the VAL client or server indicating whether the SEALDD flow subscription request was successfully processed or not.

Step 4: The SEALDD client generates measurements and detects if the notification criteria have been met by these measurements.

Step 5: If the notification criteria have been met, the SEALDD client or server sends a SEALDD flow notification to the SEALDD client or server. The measurement(s) are incorporated within the notification as proposed in Table 9.

Step 8: The VAL client or server processes the notification by extracting the SEALDD measurement(s) from the notification payload.

Step 9: The VAL client or server may respond back to the SEALDD client or server indicating that the measurement(s) were successfully received.

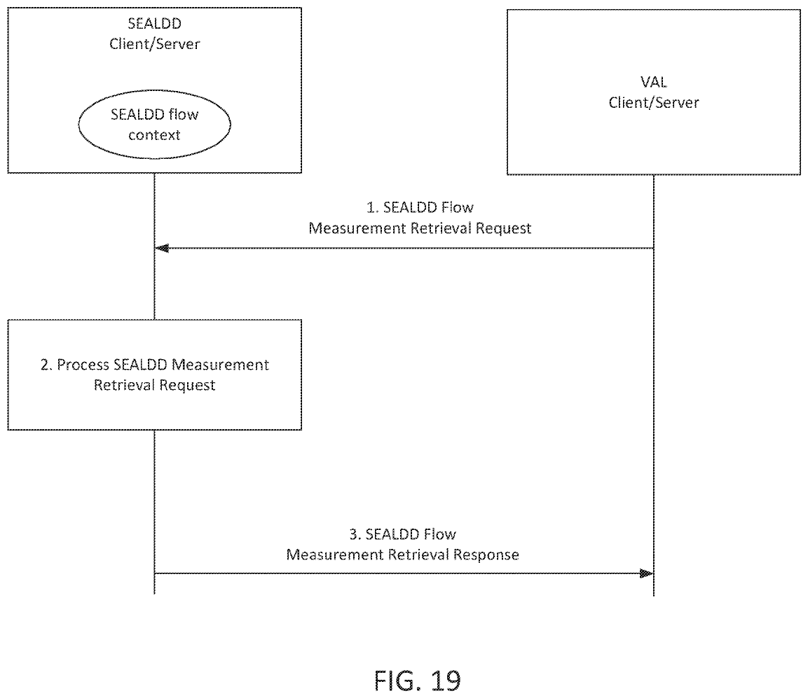

As shown in FIG. 19, an alternative to using subscriptions to receive SEALDD measurements from a SEALDD client or server via notifications, a VAL client or server may instead retrieve the measurements from the SEALDD client or server. For example, a VAL client or server may periodically poll a SEALDD client or server to fetch SEALD measurements.

Step 1: The VAL client or server issues a SEALDD flow retrieval request to the SEALDD client or server to check if there are any SEALDD measurements that have been generated by the VAL client or server. The retrieval request may comprise one or more of the information elements defined in Table 4. The request is targeted towards a SEALDD client or server address (e.g., IP address and port and/or URI) that supports receiving VAL client or server requests to retrieve SEALDD measurements associated with a SEALDD flow. For example, a SEALDD flow message exit point as defined in Table 1.

Step 2-3: Upon receiving the retrieval request, the SEALDD client or server checks if any measurements are available that match the specified retrieval request and any filter criteria defined within the request. If yes, the SEALDD client or server forwards the SEALDD measurements to the VAL client or server within the SEALDD flow retrieval response that it returns.

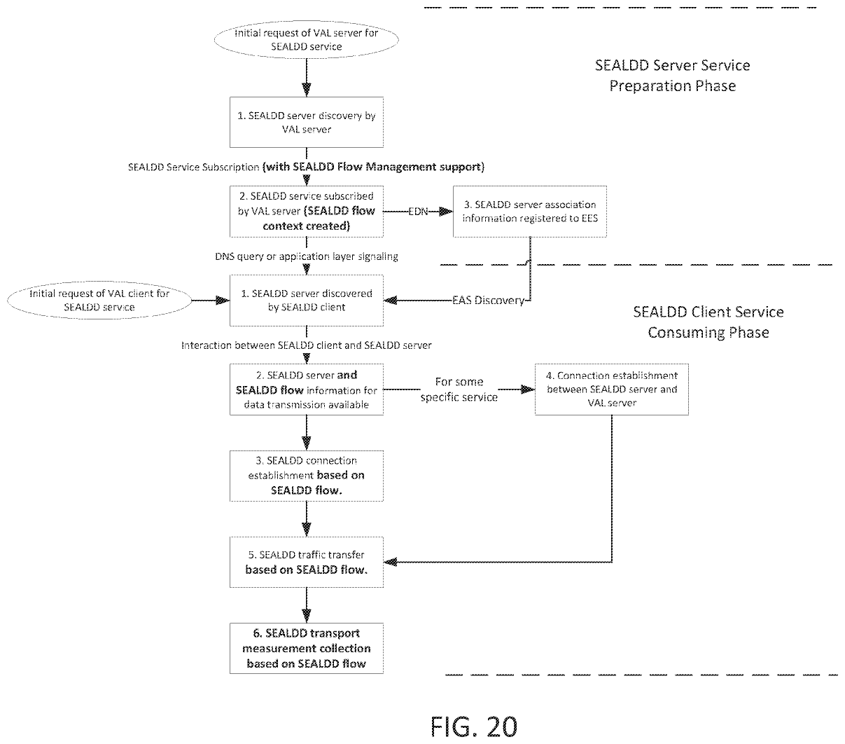

FIG. 20 shows enhancements to the 3GPP SA6 SEALDD service lifecycle defined in. The enhancements comprise support for the proposed SEALDD flow management functionality.

Within the SA6 defined SEALDD service lifecycle, SEALDD flow management support may be added as follows

In Step 2 of the SEALDD Server Service Preparation Phase, SEALDD flow management support may be added based on the functionality proposed in FIG. 11. Alternatively, a VAL server may create one or more SEALDD flows via the functionality proposed in FIG. 6.

In Step 2 of the SEALDD Client Service Consuming Phase, SEALDD flow management support may be added based on the functionality proposed in FIG. 12. Alternatively, a VAL client may discover one or more SEALDD flows via the functionality proposed in FIG. 7.

In Step 3 of the SEALDD Client Service Consuming Phase, SEALDD connections may be established based on the redundant transport requirements configured within the SEALDD flow context as proposed in Table 1.

In Step 5 of the SEALDD Client Service Consuming Phase, SEALDD traffic transfer may be performed based on the functionality defined within FIG. 15, FIG. 16, and FIG. 17.

In Step 6 of the SEALDD Client Service Consuming Phase, SEALDD transport measurements may be performed based on the functionality defined within FIG. 18 and FIG. 19.

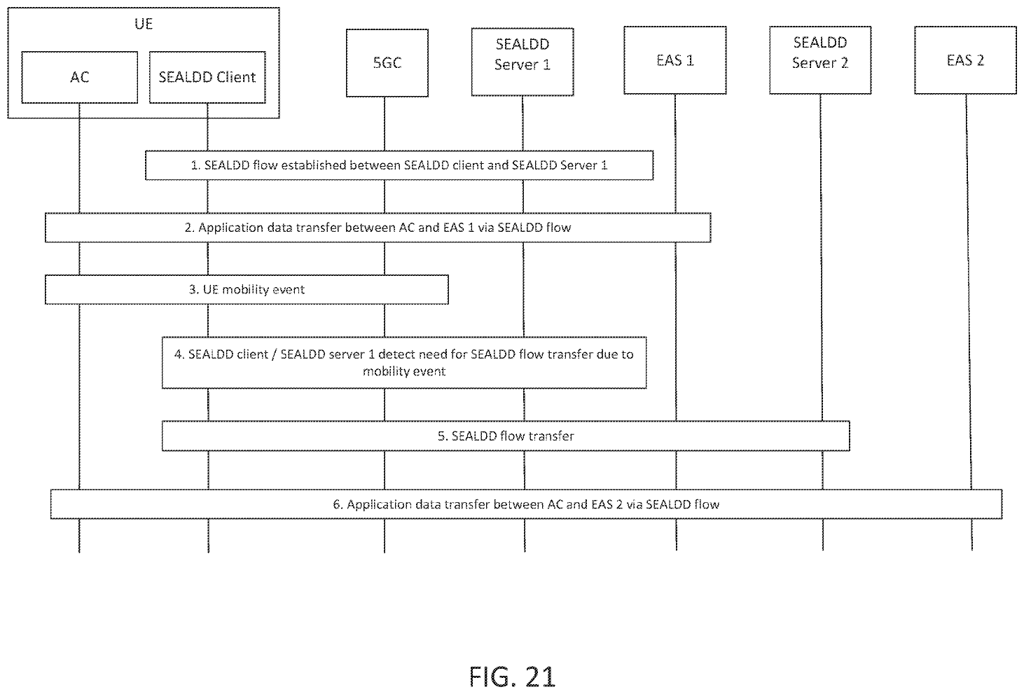

As shown in FIG. 21, SEALDD clients and servers may utilize SEALDD flow management procedures to ensure service continuity due to a UE's mobility. In FIG. 21, a SEALDD client on a UE establishes a SEALDD flow with SEALDD server 1 to send application data to EAS 1. The UE may move, triggering a UE mobility event in the 5GC. This may result in a notification of the UE mobility event being sent to SEALDD server 1 (either directly or indirectly via another function such as an EES or ECS). SEALDD server 1 may initiate a SEALDD flow to SEALDD server 2. The SEALDD server 1 may transfer SEALDD flow context to SEALDD server 2.

Step 1: A SEALDD flow is established between the SEALDD client on the UE and SEALDD server 1. This flow may be established using the aforementioned SEALDD flow creation or update procedure defined in FIG. 6. SEALDD server 1 may also subscribe to receive notifications of UE mobility event from the 5GC.

Step 2: The AC on the UE and EAS 1 exchange application messages via the established SEALDD flow. This exchange may occur using the aforementioned SEALDD flow-based message transmission and reception procedures defined in FIG. 15, FIG. 16, and FIG. 17.

Step 3: The UE changes location causing a UE mobility event to occur. This event may be triggered by the UE or by the 5GC.

Step 4: The SEALDD client and/or server may detect the need for the SEALDD flow to be transferred to another SEALDD server due to the UE's location requiring a transition from EAS 1 to EAS 2. This detection may involve the SEALDD client and/or server detecting the UE mobility event. For example, the SEALDD client may receive information regarding the UE mobility event from the AC, from lower layers of the UE, or from sensors in the UE. Alternatively, SEALDD server 1 may receive information regarding the UE mobility event from the 5GC, EAS 1 or another entity in the system such as an EES or ECS (not shown in FIG. 21). The received information may comprise information (e.g., identifiers, network addresses, etc.) regarding SEALDD server 2 and/or EAS 2.

Step 5: The SEALDD flow is transferred between SEALDD server 1 and SEALDD server 2. This transfer may occur using the aforementioned SEALDD flow context transfer procedure defined in FIG. 14. If necessary, SEALDD server 1 and/or SEALDD server 2 may also perform AF influence traffic routing with the 5GC for the application traffic. SEALDD server 1 or SEALDD server 2 may send a notification to the SEALDD client to notify it that the SEALDD flow has been transferred. The SEALDD client establish a connection to SEALD server 2 as a result of the notification. SEALDD server 2 may also subscribe to receive notifications of UE mobility event from the 5GC while SEALDD server 1 may also unsubscribe to receiving notifications of UE mobility event from the 5GC.

Step 6: The AC on the UE and EAS 2 exchange application messages via the established SEALDD flow. This exchange may occur using the aforementioned SEALDD flow-based message transmission and reception procedures defined in FIG. 15 and FIG. 16.

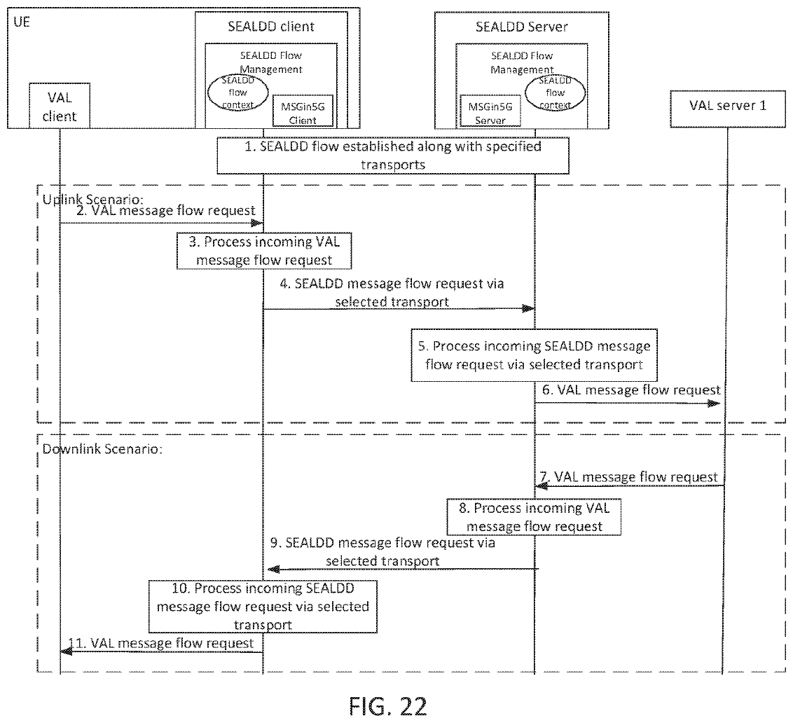

As shown in FIG. 22 a SEALDD flow may be configured with information specifying which transport mechanisms may be used for the SEALDD flow.

As one example of integration of SEALDD and MSGin5G mechanisms, the VAL client or server and the SEALDD client or server may be enabled to trigger directly MSGin5G requests (as an alternative to SEALDD requests). When a MSGin5G request is provided, the SEALDD client or server may determine whether to use MSGin5G messaging to the counterpart SEALDD entity (therefore acting as a MSGin5G entity), whether to select a specific delivery mechanism (e.g. device triggering, NIDD) or whether SEALDD delivery mechanisms should be applied. In the latter case, the payload or the MSGin5G message may be encapsulated or translated into formatted as SEALDD messages.

In an alternative example of integration of SEALDD and MSGin5G mechanisms, the VAL client or server and the SEALDD client or server may trigger SEALDD requests, and the SEALDD client or server may determine to use MSGin5G messaging to the counterpart SEALDD entity instead of SEALDD messages, therefore acting as a message translator. The SEALDD MSGin5G entity may choose the specific MSGin5G delivery mechanism (e.g. device triggering, NIDD) to be applied.

Step 1: A SEALDD flow is established. The flow may be established based on the procedure defined in FIG. 6, FIG. 11, or FIG. 12. During the establishment of the SEALDD flow one or more transports may be specified (e.g., SEALDD, MSGin5G, etc.). In addition, one or more delivery mechanisms (e.g. device triggering, NIDD) may also be specified for the flow. This information may be specified within the SEALDD flow context as proposed in Table 1 and stored by the SEALDD client or server.

### Uplink Scenario:

Step 2: For uplink traffic, a VAL client sends a request to SEALDD client with application data.

Step 3: Upon receiving the request from VAL client, the SEALDD client determines the SEALDD flow that the VAL message is associated with. The SEALDD client may make this determination based on the procedure defined in FIG. 15. The SEALDD client may use information in the SEALDD flow context to determine that transport required (e.g., SEALDD, MSGin5G) to send the VAL messages to the SEALDD server. Using the SEALDD flow context policies the SEALDD client may also determine whether message aggregation, message store-and-forwarding, message segmentation and reassembly is required. Using the SEALDD flow context the SEALDD client may also determine the delivery mechanism required for the MSGin5G service such as IP, NIDD or SMS.

Step 4: The SEALDD client delivers the VAL message to the SEALDD server. If the message is transferred via a MSGin5G transport, the MSGin5G client and MSGin5G server are used to deliver the message (i.e., the VAL message is delivered within the MSGin5G message payload using the MSGin5G messaging protocol).

Step 5: Upon receiving the message, the SEALDD server parses the VAL message from the SEALDD message. If the message is transferred via a MSGin5G transport, the MSGin5G server parses the VAL message from the MSGin5G message.

Step 6: The SEALDD server delivers the VAL message to the VAL server. This delivery may be based on the procedure defined in FIG. 16 or FIG. 17.

### Downlink Scenario:

Step 7: For downlink traffic, a VAL server sends a request to SEALDD server with application data.

Step 8: Upon receiving the request from VAL server, the SEALDD server determines the SEALDD flow that the VAL message is associated with. The SEALDD server may make this determination based on the procedure defined in FIG. 15. The SEALDD server may use information in the SEALDD flow context to determine that transport required to send the VAL messages to the SEALDD client. Using the SEALDD flow context policies the SEALDD server may also determine whether message aggregation, message store-and-forwarding, message segmentation and reassembly is required. Using the SEALDD flow context the SEALDD server may also determine the delivery mechanism required for the MSGin5G service such as IP, NIDD or SMS.

Step 9: The SEALDD server delivers the VAL message to the SEALDD client. If the message is transferred via a MSGin5G transport, the MSGin5G server and MSGin5G client are used to deliver the message (i.e., the VAL message is delivered within the MSGin5G message payload using the MSGin5G messaging protocol).

Step 10: Upon receiving the message, the SEALDD client parses the VAL message from the SEALDD message. If the message is transferred via a MSGin5G transport, the MSGin5G client parses the VAL message from the MSGin5G message

Step 11: The SEALDD client delivers the VAL message to the VAL client. This delivery may be based on the procedure defined in FIG. 16 or FIG. 17.

In one example, SEALDD clients and servers may implement SEALDD flow context as RESTful resources. The resources may have unique addresses (e.g. URIs, URNs, etc.) and may also have one or more attributes that comprise resource data and/or metadata. These flow context resources may be created, retrieved, updated, or deleted by VAL clients and servers as well as other SEALDD clients and servers. The SEALDD clients and servers may support APIs for these resource that are based on RESTful protocols such as HTTP and CoAP. In addition, subscriptions may also be made to flow contexts resources to receive notifications if any modifications are made to the resources.

In another example, SEALDD clients and servers may implement SEALDD flow context as topics within the topic space of a message broker (e.g., MQTT broker, AMQP broker, etc.). A SEALDD client or server may function as the message broker. Alternatively, the message broker may be hosted external to the SEALDD client or server by another node or function in the network which the SEALDD client or server communicates with to create, update, retrieve, delete, and subscribe to SEALDD flow context topics.

The topics may have unique addresses (e.g. topic names, etc.) and also one or more attributes that comprise topic data and/or metadata. These flow context topics may be published to or subscribed to by VAL clients and servers as well as other SEALDD clients and servers.

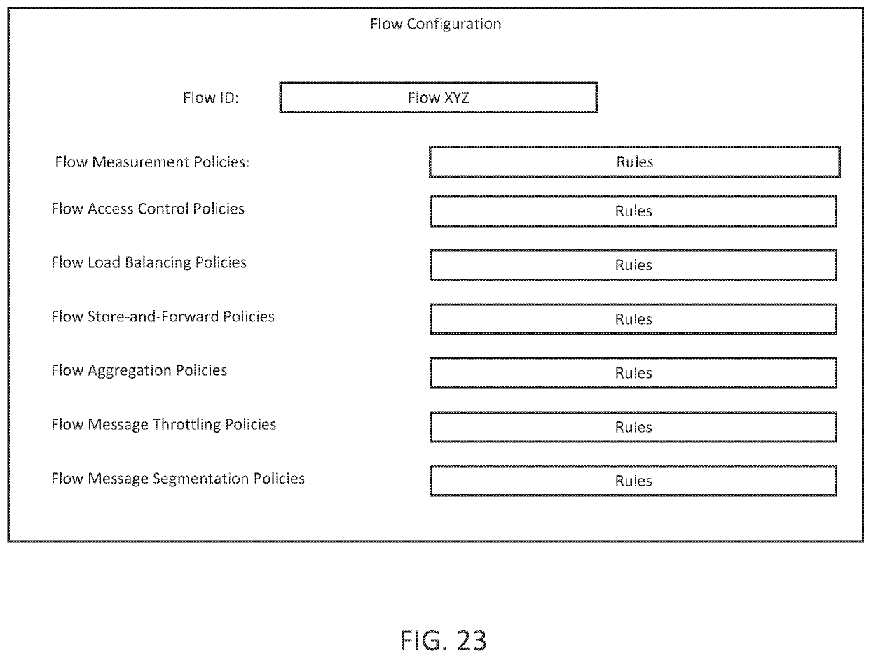

FIG. 23 shows an example GUI in which a user may configure a SEALDD flow.

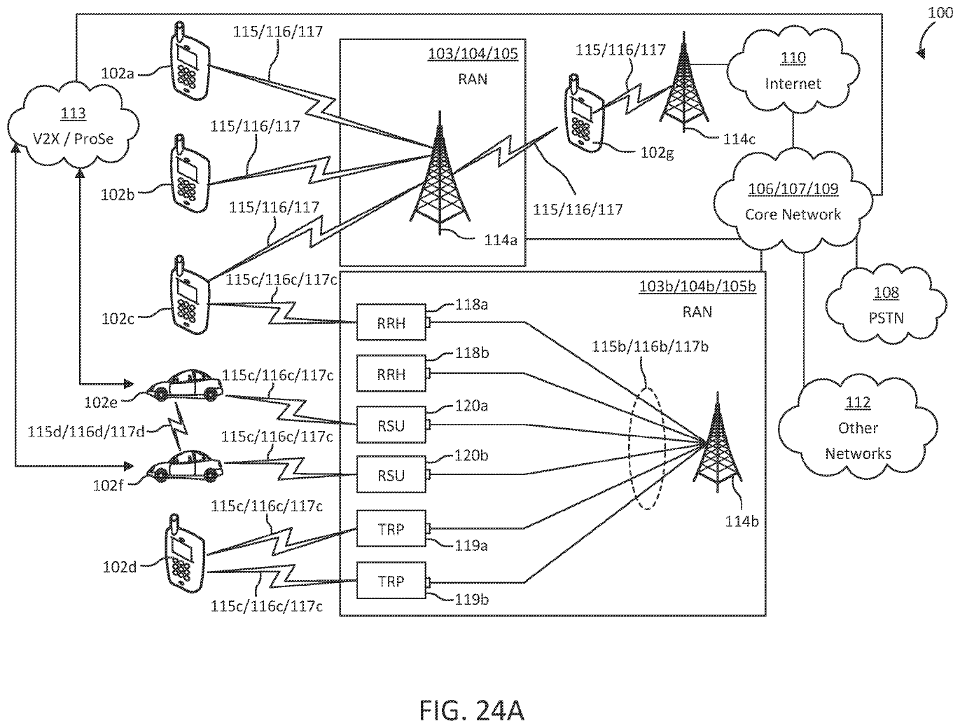

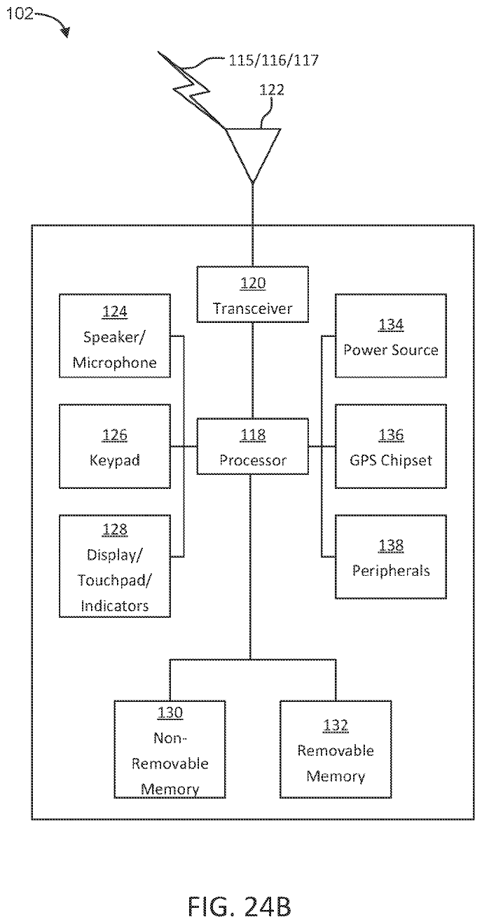

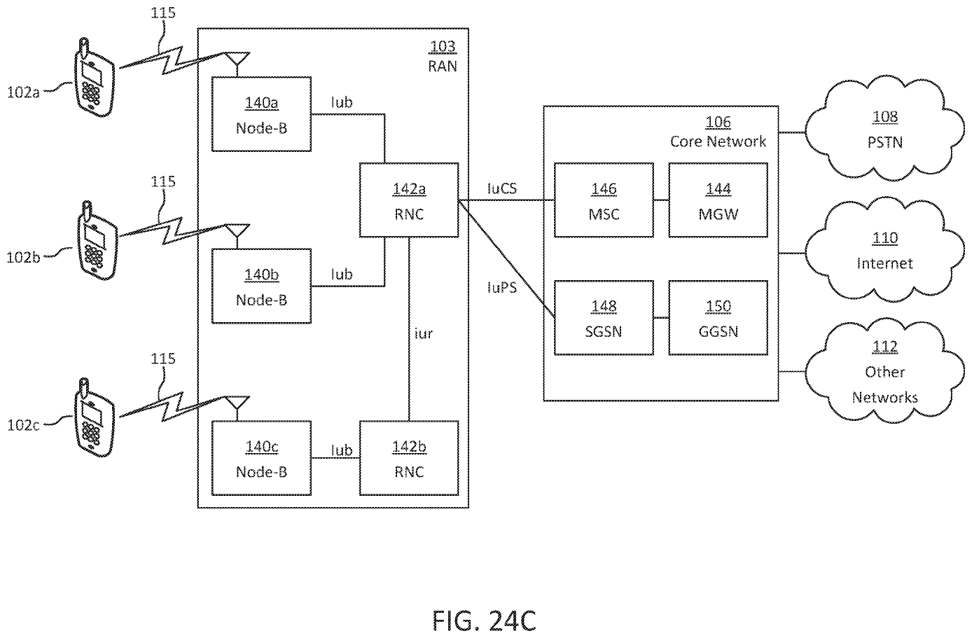

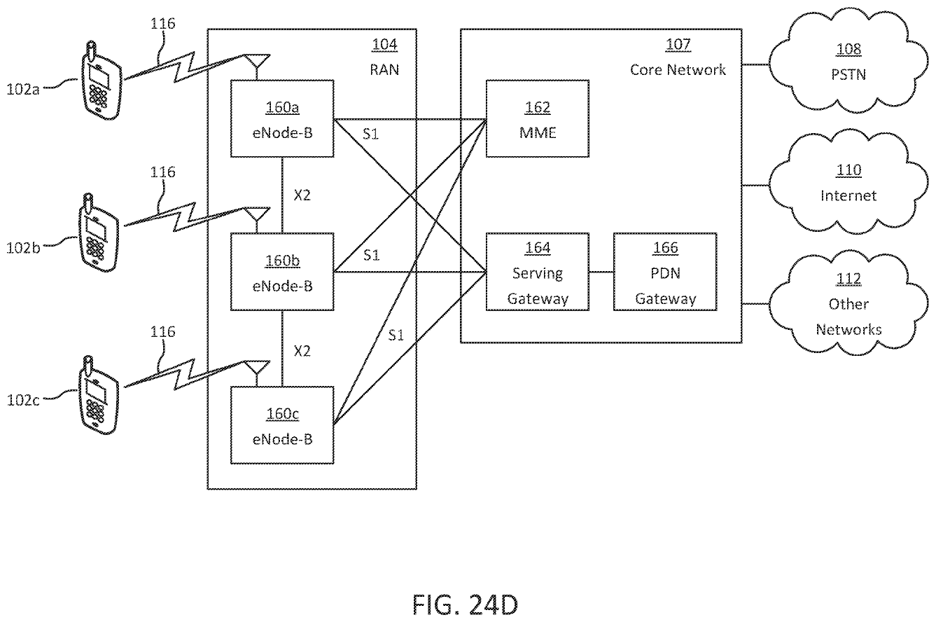

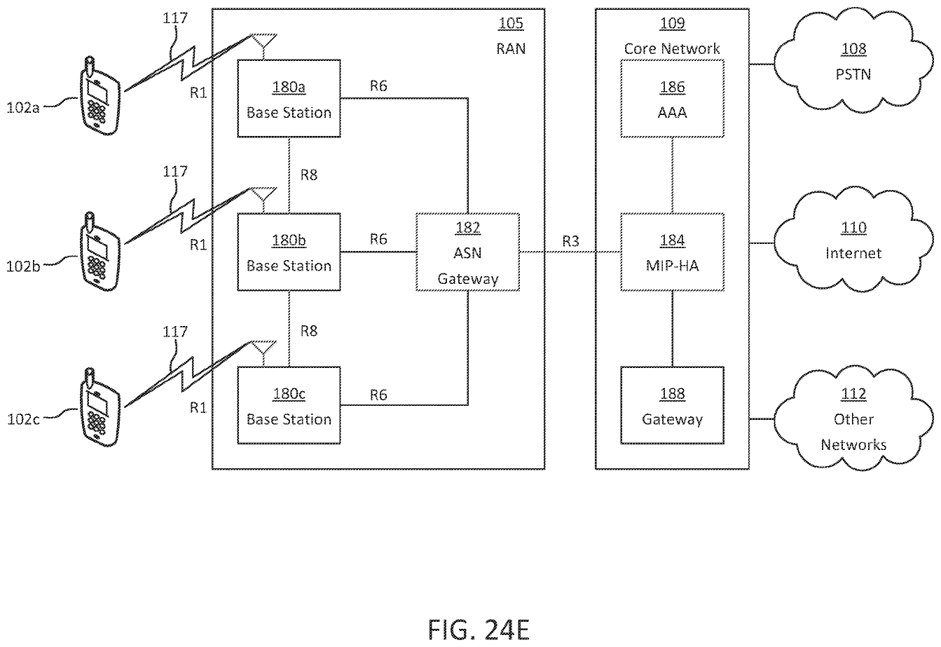

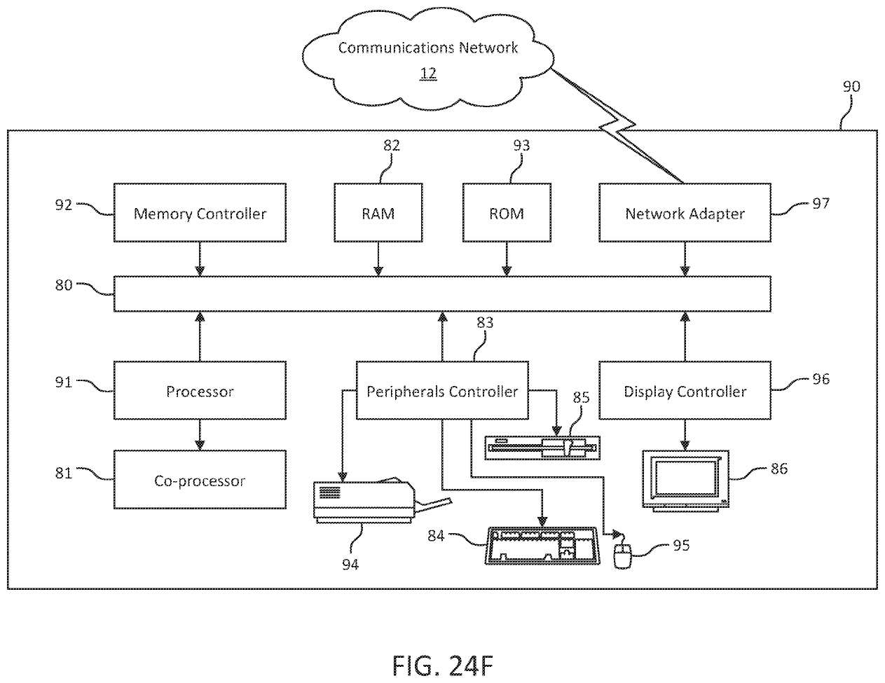

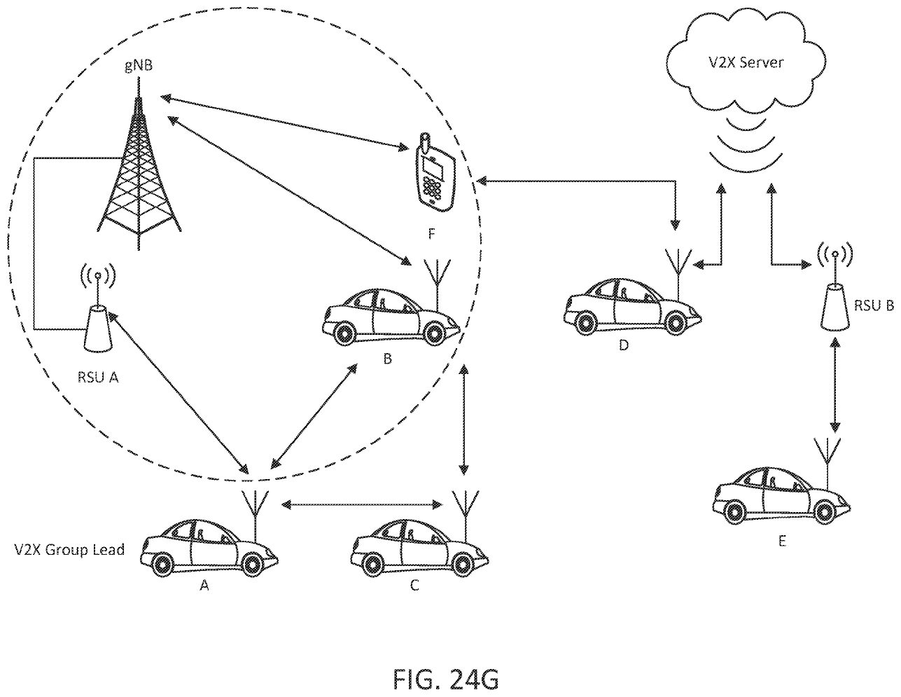

FIG. 24A illustrates one embodiment of an example communications system 100 in which the methods and apparatuses described and claimed herein may be embodied. As shown, the example communications system 100 may comprise wireless transmit/receive units (WTRUs) 102a, 102b, 102c, 102d, 102e, 102f, and/or 102g (which generally or collectively may be referred to as WTRU 102), a radio access network (RAN) 103/104/105/103b/104b/105b, a core network 106/107/109, a public switched telephone network (PSTN) 108, the Internet 110, other networks 112, and V2X server (or ProSe function and server) 113, though it will be appreciated that the disclosed embodiments contemplate any number of WTRUs, base stations, networks, and/or network elements. Each of the WTRUs 102a, 102b, 102c, 102d, 102e, 102f, 102g may be any type of apparatus or device configured to operate and/or communicate in a wireless environment. Although each WTRU 102a, 102b, 102c, 102d, 102e, 102f, 102g is depicted in FIGS. 24A-24E as a hand-held wireless communications apparatus, it is understood that with the wide variety of use cases contemplated for 5G wireless communications, each WTRU may comprise or be embodied in any type of apparatus or device configured to transmit and/or receive wireless signals, including, by way of example only, user equipment (UE), a mobile station, a fixed or mobile subscriber unit, a pager, a cellular telephone, a personal digital assistant (PDA), a smartphone, a laptop, a tablet, a netbook, a notebook computer, a personal computer, a wireless sensor, consumer electronics, a wearable device such as a smart watch or smart clothing, a medical or eHealth device, a robot, industrial equipment, a drone, a vehicle such as a car, truck, train, or airplane, and the like.

The communications system 100 may also include a base station 114a and a base station 114b. Base stations 114a may be any type of device configured to wirelessly interface with at least one of the WTRUs 102a, 102b, 102c to facilitate access to one or more communication networks, such as the core network 106/107/109, the Internet 110, and/or the other networks 112. Base stations 114b may be any type of device configured to wiredly and/or wirelessly interface with at least one of the RRHs (Remote Radio Heads) 118a, 118b, TRPs (Transmission and Reception Points) 119a, 119b, and/or RSUs (Roadside Units) 120a and 120b to facilitate access to one or more communication networks, such as the core network 106/107/109, the Internet 110, the other networks 112, and/or V2X server (or ProSe function and server) 113. RRHs 118a, 118b may be any type of device configured to wirelessly interface with at least one of the WTRU 102c, to facilitate access to one or more communication networks, such as the core network 106/107/109, the Internet 110, and/or the other networks 112. TRPs 119a, 119b may be any type of device configured to wirelessly interface with at least one of the WTRU 102d, to facilitate access to one or more communication networks, such as the core network 106/107/109, the Internet 110, and/or the other networks 112. RSUs 120a and 120b may be any type of device configured to wirelessly interface with at least one of the WTRU 102e or 102f, to facilitate access to one or more communication networks, such as the core network 106/107/109, the Internet 110, the other networks 112, and/or V2X server (or ProSe function and server) 113. By way of example, the base stations 114a, 114b may be a base transceiver station (BTS), a Node-B, an eNode B, a Home Node B, a Home e Node B, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 103/104/105, which may also include other base stations and/or network elements (not shown), such as a base station controller (BSC), a radio network controller (RNC), relay nodes, etc. The base station 114b may be part of the RAN 103b/104b/105b, which may also include other base stations and/or network elements (not shown), such as a base station controller (BSC), a radio network controller (RNC), relay nodes, etc. The base station 114a may be configured to transmit and/or receive wireless signals within a particular geographic region, which may be referred to as a cell (not shown). The base station 114b may be configured to transmit and/or receive wired and/or wireless signals within a particular geographic region, which may be referred to as a cell (not shown). The cell may further be divided into cell sectors. For example, the cell associated with the base station 114a may be divided into three sectors. Thus, in an embodiment, the base station 114a may include three transceivers, e.g., one for each sector of the cell. In an embodiment, the base station 114a may employ multiple-input multiple output (MIMO) technology and, therefore, may utilize multiple transceivers for each sector of the cell.

The base stations 114a may communicate with one or more of the WTRUs 102a, 102b, 102c over an air interface 115/116/117, which may be any suitable wireless communication link (e.g., radio frequency (RF), microwave, infrared (IR), ultraviolet (UV), visible light, cmWave, mmWave, etc.). The air interface 115/116/117 may be established using any suitable radio access technology (RAT).

The base stations 114b may communicate with one or more of the RRHs 118a, 118b, TRPs 119a, 119b, and/or RSUs 120a and 120b, over a wired or air interface 115b/116b/117b, which may be any suitable wired (e.g., cable, optical fiber, etc.) or wireless communication link (e.g., radio frequency (RF), microwave, infrared (IR), ultraviolet (UV), visible light, cmWave, mmWave, etc.). The air interface 115b/116b/117b may be established using any suitable radio access technology (RAT).

The RRHs 118a, 118b, TRPs 119a, 119b and/or RSUs 120a, 120b, may communicate with one or more of the WTRUs 102c, 102d, 102e, 102f over an air interface 115c/116c/117c, which may be any suitable wireless communication link (e.g., radio frequency (RF), microwave, infrared (IR), ultraviolet (UV), visible light, cmWave, mmWave, etc.). The air interface 115c/116c/117c may be established using any suitable radio access technology (RAT).

The WTRUs 102a, 102b, 102c, 102d, 102e, 102f, and/or 102g may communicate with one another over an air interface 115d/116d/117d (not shown in the figures), which may be any suitable wireless communication link (e.g., radio frequency (RF), microwave, infrared (IR), ultraviolet (UV), visible light, cmWave, mmWave, etc.). The air interface 115d/116d/117d may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 103/104/105 and the WTRUs 102a, 102b, 102c, or RRHs 118a, 118b, TRPs 119a, 119b and RSUs 120a, 120b, in the RAN 103b/104b/105b and the WTRUs 102c, 102d, 102e, 102f, may implement a radio technology such as Universal Mobile Telecommunications System (UMTS) Terrestrial Radio Access (UTRA), which may establish the air interface 115/116/117 or 115c/116c/117c respectively using wideband CDMA (WCDMA). WCDMA may include communication protocols such as High-Speed Packet Access (HSPA) and/or Evolved HSPA (HSPA+). HSPA may include High-Speed Downlink Packet Access (HSDPA) and/or High-Speed Uplink Packet Access (HSUPA).

In an embodiment, the base station 114a and the WTRUs 102a, 102b. 102c, or RRHs 118a, 118b, TRPs 119a, 119b, and/or RSUs 120a, 120b, in the RAN 103b/104b/105b and the WTRUs 102c, 102d, may implement a radio technology such as Evolved UMTS Terrestrial Radio Access (E-UTRA), which may establish the air interface 115/116/117 or 115c/116c/117c respectively using Long Term Evolution (LTE) and/or LTE-Advanced (LTE-A). In the future, the air interface 115/116/117 may implement 3GPP NR technology. The LTE and LTE-A technology includes LTE D2D and V2X technologies and interface (such as Sidelink communications, etc.) The 3GPP NR technology includes NR V2X technologies and interface (such as Sidelink communications, etc.)

In an embodiment, the base station 114a in the RAN 103/104/105 and the WTRUs 102a, 102b, 102c, or RRHs 118a, 118b, TRPs 119a, 119b and/or RSUs 120a, 120b, in the RAN 103b/104b/105b and the WTRUs 102c, 102d, 102e, 102f may implement radio technologies such as IEEE 802.16 (e.g., Worldwide Interoperability for Microwave Access (WiMAX)), CDMA2000, CDMA2000 1×, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114c in FIG. 24A may be a wireless router, Home Node B, Home eNode B, or access point, for example, and may utilize any suitable RAT for facilitating wireless connectivity in a localized area, such as a place of business, a home, a vehicle, a campus, and the like. In an embodiment, the base station 114c and the WTRUs 102e, may implement a radio technology such as IEEE 802.11 to establish a wireless local area network (WLAN). In an embodiment, the base station 114c and the WTRUs 102d, may implement a radio technology such as IEEE 802.15 to establish a wireless personal area network (WPAN). In yet another embodiment, the base station 114c and the WTRUs 102e, may utilize a cellular-based RAT (e.g., WCDMA, CDMA2000, GSM, LTE, LTE-A, etc.) to establish a picocell or femtocell. As shown in FIG. 24A, the base station 114b may have a direct connection to the Internet 110. Thus, the base station 114c may not be required to access the Internet 110 via the core network 106/107/109.

The RAN 103/104/105 and/or RAN 103b/104b/105b may be in communication with the core network 106/107/109, which may be any type of network configured to provide voice, data, applications, and/or voice over internet protocol (VOIP) services to one or more of the WTRUs 102a, 102b, 102c, 102d. For example, the core network 106/107/109 may provide call control, billing services, mobile location-based services, pre-paid calling, Internet connectivity, video distribution, etc., and/or perform high-level security functions, such as user authentication.

Although not shown in FIG. 24A, it will be appreciated that the RAN 103/104/105 and/or RAN 103b/104b/105b and/or the core network 106/107/109 may be in direct or indirect communication with other RANs that employ the same RAT as the RAN 103/104/105 and/or RAN 103b/104b/105b or a different RAT. For example, in addition to being connected to the RAN 103/104/105 and/or RAN 103b/104b/105b, which may be utilizing an E-UTRA radio technology, the core network 106/107/109 may also be in communication with another RAN (not shown) employing a GSM radio technology.

The core network 106/107/109 may also serve as a gateway for the WTRUs 102a, 102b, 102c, 102d, 102e to access the PSTN 108, the Internet 110, and/or other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and the internet protocol (IP) in the TCP/IP internet protocol suite. The networks 112 may include wired or wireless communications networks owned and/or operated by other service providers. For example, the networks 112 may include another core network connected to one or more RANs, which may employ the same RAT as the RAN 103/104/105 and/or RAN 103b/104b/105b or a different RAT.

Some or all of the WTRUs 102a, 102b, 102c, 102d in the communications system 100 may include multi-mode capabilities, e.g., the WTRUs 102a, 102b, 102c, 102d, and 102e may include multiple transceivers for communicating with different wireless networks over different wireless links. For example, the WTRU 102e shown in FIG. 24A may be configured to communicate with the base station 114a, which may employ a cellular-based radio technology, and with the base station 114c, which may employ an IEEE 802 radio technology.

FIG. 24B is a block diagram of an example apparatus or device configured for wireless communications in accordance with the embodiments illustrated herein, such as for example, a WTRU 102. As shown in FIG. 24B, the example WTRU 102 may include a processor 118, a transceiver 120, a transmit/receive element 122, a speaker/microphone 124, a keypad 126, a display/touchpad/indicators 128, non-removable memory 130, removable memory 132, a power source 134, a global positioning system (GPS) chipset 136, and other peripherals 138. It will be appreciated that the WTRU 102 may include any sub-combination of the foregoing elements while remaining consistent with an embodiment. Also, embodiments contemplate that the base stations 114a and 114b, and/or the nodes that base stations 114a and 114b may represent, such as but not limited to transceiver station (BTS), a Node-B, a site controller, an access point (AP), a home node-B, an evolved home node-B (eNodeB), a home evolved node-B (HeNB), a home evolved node-B gateway, and proxy nodes, among others, may include some or all of the elements depicted in FIG. 24B and described herein.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Array (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 24B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 115/116/117. For example, in an embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet an embodiment, the transmit/receive element 122 may be configured to transmit and receive both RF and light signals. It will be appreciated that the transmit/receive element 122 may be configured to transmit and/or receive any combination of wireless signals.

In addition, although the transmit/receive element 122 is depicted in FIG. 24B as a single element, the WTRU 102 may include any number of transmit/receive elements 122. More specifically, the WTRU 102 may employ MIMO technology. Thus, in an embodiment, the WTRU 102 may include two or more transmit/receive elements 122 (e.g., multiple antennas) for transmitting and receiving wireless signals over the air interface 115/116/117.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as UTRA and IEEE 802.11, for example.

The processor 118 of the WTRU 102 may be coupled to, and may receive user input data from, the speaker/microphone 124, the keypad 126, and/or the display/touchpad/indicators 128 (e.g., a liquid crystal display (LCD) display unit or organic light-emitting diode (OLED) display unit). The processor 118 may also output user data to the speaker/microphone 124, the keypad 126, and/or the display/touchpad/indicators 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In an embodiment, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries, solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 115/116/117 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include various sensors such as an accelerometer, biometrics (e.g., finger print) sensors, an e-compass, a satellite transceiver, a digital camera (for photographs or video), a universal serial bus (USB) port or other interconnect interfaces, a vibration device, a television transceiver, a hands free headset, a Bluetooth® module, a frequency modulated (FM) radio unit, a digital music player, a media player, a video game player module, an Internet browser, and the like.

The WTRU 102 may be embodied in other apparatuses or devices, such as a sensor, consumer electronics, a wearable device such as a smart watch or smart clothing, a medical or cHealth device, a robot, industrial equipment, a drone, a vehicle such as a car, truck, train, or airplane. The WTRU 102 may connect to other components, modules, or systems of such apparatuses or devices via one or more interconnect interfaces, such as an interconnect interface that may comprise one of the peripherals 138.

FIG. 24C is a system diagram of the RAN 103 and the core network 106 according to an embodiment. As noted above, the RAN 103 may employ a UTRA radio technology to communicate with the WTRUs 102a, 102b, and 102c over the air interface 115. The RAN 103 may also be in communication with the core network 106. As shown in FIG. 24C, the RAN 103 may include Node-Bs 140a, 140b, 140c, which may each include one or more transceivers for communicating with the WTRUs 102a, 102b, 102c over the air interface 115. The Node-Bs 140a, 140b, 140c may each be associated with a particular cell (not shown) within the RAN 103. The RAN 103 may also include RNCs 142a, 142b. It will be appreciated that the RAN 103 may include any number of Node-Bs and RNCs while remaining consistent with an embodiment.

As shown in FIG. 24C, the Node-Bs 140a, 140b may be in communication with the RNC 142a. Additionally, the Node-B 140c may be in communication with the RNC 142b. The Node-Bs 140a, 140b, 140c may communicate with the respective RNCs 142a, 142b via an lub interface. The RNCs 142a, 142b may be in communication with one another via an Iur interface. Each of the RNCs 142a, 142b may be configured to control the respective Node-Bs 140a, 140b, 140c to which it is connected. In addition, each of the RNCs 142a, 142b may be configured to carry out or support other functionality, such as outer loop power control, load control, admission control, packet scheduling, handover control, macro-diversity, security functions, data encryption, and the like.

The core network 106 shown in FIG. 24C may include a media gateway (MGW) 144, a mobile switching center (MSC) 146, a serving GPRS support node (SGSN) 148, and/or a gateway GPRS support node (GGSN) 150. While each of the foregoing elements are depicted as part of the core network 106, it will be appreciated that any one of these elements may be owned and/or operated by an entity other than the core network operator.

The RNC 142a in the RAN 103 may be connected to the MSC 146 in the core network 106 via an IuCS interface. The MSC 146 may be connected to the MGW 144. The MSC 146 and the MGW 144 may provide the WTRUs 102a, 102b, 102c with access to circuit-switched networks, such as the PSTN 108, to facilitate communications between the WTRUs 102a, 102b, 102c and traditional land-line communications devices.

The RNC 142a in the RAN 103 may also be connected to the SGSN 148 in the core network 106 via an IuPS interface. The SGSN 148 may be connected to the GGSN 150. The SGSN 148 and the GGSN 150 may provide the WTRUs 102a, 102b, 102c with access to packet-switched networks, such as the Internet 110, to facilitate communications between and the WTRUs 102a, 102b, 102c and IP-enabled devices.

As noted above, the core network 106 may also be connected to the networks 112, which may include other wired or wireless networks that are owned and/or operated by other service providers.

FIG. 24D is a system diagram of the RAN 104 and the core network 107 according to an embodiment. As noted above, the RAN 104 may employ an E-UTRA radio technology to communicate with the WTRUs 102a, 102b, and 102c over the air interface 116. The RAN 104 may also be in communication with the core network 107.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In an embodiment, the eNode-Bs 160a, 160b, 160c may implement MIMO technology. Thus, the eNode-B 160a, for example, may use multiple antennas to transmit wireless signals to, and receive wireless signals from, the WTRU 102a.

Each of the eNode-Bs 160a, 160b, and 160c may be associated with a particular cell (not shown) and may be configured to handle radio resource management decisions, handover decisions, scheduling of users in the uplink and/or downlink, and the like. As shown in FIG. 24D, the eNode-Bs 160a, 160b, 160c may communicate with one another over an X2 interface.

The core network 107 shown in FIG. 24D may include a mobility management gateway (MME) 162, a serving gateway 164, and a packet data network (PDN) gateway 166. While each of the foregoing elements are depicted as part of the core network 107, it will be appreciated that any one of these elements may be owned and/or operated by an entity other than the core network operator.

The MME 162 may be connected to each of the eNode-Bs 160a, 160b, and 160c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may also provide a control plane function for switching between the RAN 104 and other RANs (not shown) that employ other radio technologies, such as GSM or WCDMA.

The serving gateway 164 may be connected to each of the eNode-Bs 160a, 160b, and 160c in the RAN 104 via the S1 interface. The serving gateway 164 may generally route and forward user data packets to/from the WTRUs 102a, 102b, 102c. The serving gateway 164 may also perform other functions, such as anchoring user planes during inter-eNode B handovers, triggering paging when downlink data is available for the WTRUs 102a, 102b, 102c, managing and storing contexts of the WTRUs 102a, 102b, 102c, and the like.

The serving gateway 164 may also be connected to the PDN gateway 166, which may provide the WTRUs 102a, 102b, 102c with access to packet-switched networks, such as the Internet 110, to facilitate communications between the WTRUs 102a, 102b, 102c and IP-enabled devices.

The core network 107 may facilitate communications with other networks. For example, the core network 107 may provide the WTRUs 102a, 102b, 102c with access to circuit-switched networks, such as the PSTN 108, to facilitate communications between the WTRUs 102a, 102b, 102c and traditional land-line communications devices. For example, the core network 107 may include, or may communicate with, an IP gateway (e.g., an IP multimedia subsystem (IMS) server) that serves as an interface between the core network 107 and the PSTN 108. In addition, the core network 107 may provide the WTRUs 102a, 102b, 102c with access to the networks 112, which may include other wired or wireless networks that are owned and/or operated by other service providers.

FIG. 24E is a system diagram of the RAN 105 and the core network 109 according to an embodiment. The RAN 105 may be an access service network (ASN) that employs IEEE 802.16 radio technology to communicate with the WTRUs 102a, 102b, and 102c over the air interface 117. As will be further discussed below, the communication links between the different functional entities of the WTRUs 102a, 102b, 102c, the RAN 105, and the core network 109 may be defined as reference points.

As shown in FIG. 24E, the RAN 105 may include base stations 180a, 180b, 180c, and an ASN gateway 182, though it will be appreciated that the RAN 105 may include any number of base stations and ASN gateways while remaining consistent with an embodiment. The base stations 180a, 180b, 180c may each be associated with a particular cell in the RAN 105 and may include one or more transceivers for communicating with the WTRUs 102a, 102b, 102c over the air interface 117. In an embodiment, the base stations 180a, 180b, 180c may implement MIMO technology. Thus, the base station 180a, for example, may use multiple antennas to transmit wireless signals to, and receive wireless signals from, the WTRU 102a. The base stations 180a, 180b, 180c may also provide mobility management functions, such as handoff triggering, tunnel establishment, radio resource management, traffic classification, quality of service (QoS) policy enforcement, and the like. The ASN gateway 182 may serve as a traffic aggregation point and may be responsible for paging, caching of subscriber profiles, routing to the core network 109, and the like.

The air interface 117 between the WTRUs 102a, 102b, 102c and the RAN 105 may be defined as an R1 reference point that implements the IEEE 802.16 specification. In addition, each of the WTRUs 102a, 102b, and 102c may establish a logical interface (not shown) with the core network 109. The logical interface between the WTRUs 102a, 102b, 102c and the core network 109 may be defined as an R2 reference point, which may be used for authentication, authorization, IP host configuration management, and/or mobility management.

The communication link between each of the base stations 180a, 180b, and 180c may be defined as an R8 reference point that includes protocols for facilitating WTRU handovers and the transfer of data between base stations. The communication link between the base stations 180a, 180b, 180c and the ASN gateway 182 may be defined as an R6 reference point. The R6 reference point may include protocols for facilitating mobility management based on mobility events associated with each of the WTRUs 102a, 102b, 102c.

As shown in FIG. 24E, the RAN 105 may be connected to the core network 109. The communication link between the RAN 105 and the core network 109 may defined as an R3 reference point that includes protocols for facilitating data transfer and mobility management capabilities, for example. The core network 109 may include a mobile IP home agent (MIP-HA) 184, an authentication, authorization, accounting (AAA) server 186, and a gateway 188. While each of the foregoing elements are depicted as part of the core network 109, it will be appreciated that any one of these elements may be owned and/or operated by an entity other than the core network operator.

The MIP-HA may be responsible for IP address management, and may enable the WTRUs 102a, 102b, and 102c to roam between different ASNs and/or different core networks. The MIP-HA 184 may provide the WTRUs 102a, 102b, 102c with access to packet-switched networks, such as the Internet 110, to facilitate communications between the WTRUs 102a, 102b, 102c and IP-enabled devices. The AAA server 186 may be responsible for user authentication and for supporting user services. The gateway 188 may facilitate interworking with other networks. For example, the gateway 188 may provide the WTRUs 102a, 102b, 102c with access to circuit-switched networks, such as the PSTN 108, to facilitate communications between the WTRUs 102a, 102b, 102c and traditional land-line communications devices. In addition, the gateway 188 may provide the WTRUs 102a, 102b, 102c with access to the networks 112, which may include other wired or wireless networks that are owned and/or operated by other service providers.

Although not shown in FIG. 24E, it will be appreciated that the RAN 105 may be connected to other ASNs and the core network 109 may be connected to other core networks. The communication link between the RAN 105 the other ASNs may be defined as an R4 reference point, which may include protocols for coordinating the mobility of the WTRUs 102a, 102b, 102c between the RAN 105 and the other ASNs. The communication link between the core network 109 and the other core networks may be defined as an R5 reference, which may include protocols for facilitating interworking between home core networks and visited core networks.

The core network entities described herein and illustrated in FIGS. 24A, 24C, 24D, and 24E are identified by the names given to those entities in certain existing 3GPP specifications, but it is understood that in the future those entities and functionalities may be identified by other names and certain entities or functions may be combined in future specifications published by 3GPP, including future 3GPP NR specifications. Thus, the particular network entities and functionalities described and illustrated in FIGS. 24A, 24B, 24C, 24D, and 24E are provided by way of example only, and it is understood that the subject matter disclosed and claimed herein may be embodied or implemented in any similar communication system, whether presently defined or defined in the future.

FIG. 24F is a block diagram of an exemplary computing system 90 in which one or more apparatuses of the communications networks illustrated in FIGS. 24A, 24C, 24D and 24E may be embodied, such as certain nodes or functional entities in the RAN 103/104/105, Core Network 106/107/109, PSTN 108, Internet 110, or Other Networks 112. Computing system 90 may comprise a computer or server and may be controlled primarily by computer readable instructions, which may be in the form of software, wherever, or by whatever means such software is stored or accessed. Such computer readable instructions may be executed within a processor 91, to cause computing system 90 to do work. The processor 91 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Array (FPGAs) circuits, any other type of integrated circuit (IC), a state machine, and the like. The processor 91 may perform signal coding, data processing, power control, input/output processing, and/or any other functionality that enables the computing system 90 to operate in a communications network. Coprocessor 81 is an optional processor, distinct from main processor 91, that may perform additional functions or assist processor 91. Processor 91 and/or coprocessor 81 may receive, generate, and process data related to the methods and apparatuses disclosed herein.

In operation, processor 91 fetches, decodes, and executes instructions, and transfers information to and from other resources via the computing system's main data-transfer path, system bus 80. Such a system bus connects the components in computing system 90 and defines the medium for data exchange. System bus 80 typically includes data lines for sending data, address lines for sending addresses, and control lines for sending interrupts and for operating the system bus. An example of such a system bus 80 is the PCI (Peripheral Component Interconnect) bus.

Memories coupled to system bus 80 include random access memory (RAM) 82 and read only memory (ROM) 93. Such memories include circuitry that allows information to be stored and retrieved. ROMs 93 generally comprise stored data that may not easily be modified. Data stored in RAM 82 may be read or changed by processor 91 or other hardware devices. Access to RAM 82 and/or ROM 93 may be controlled by memory controller 92. Memory controller 92 may provide an address translation function that translates virtual addresses into physical addresses as instructions are executed. Memory controller 92 may also provide a memory protection function that isolates processes within the system and isolates system processes from user processes. Thus, a program running in a first mode may access only memory mapped by its own process virtual address space; it may not access memory within another process's virtual address space unless memory sharing between the processes has been set up.

In addition, computing system 90 may comprise peripherals controller 83 responsible for communicating instructions from processor 91 to peripherals, such as printer 94, keyboard 84, mouse 95, and disk drive 85.

Display 86, which is controlled by display controller 96, is used to display visual output generated by computing system 90. Such visual output may include text, graphics, animated graphics, and video. The visual output may be provided in the form of a graphical user interface (GUI). Display 86 may be implemented with a CRT-based video display, an LCD-based flat-panel display, gas plasma-based flat-panel display, or a touch-panel. Display controller 96 includes electronic components required to generate a video signal that is sent to display 86.

Further, computing system 90 may comprise communication circuitry, such as for example a network adapter 97, that may be used to connect computing system 90 to an external communications network, such as the RAN 103/104/105, Core Network 106/107/109, PSTN 108, Internet 110, or Other Networks 112 of FIGS. 24A, 24B, 24C, 24D, and 24E, to enable the computing system 90 to communicate with other nodes or functional entities of those networks. The communication circuitry, alone or in combination with the processor 91, may be used to perform the transmitting and receiving steps of certain apparatuses, nodes, or functional entities described herein.

FIG. 24G illustrates one embodiment of an example communications system 111 in which the methods and apparatuses described and claimed herein may be embodied. As shown, the example communications system 111 may include wireless transmit/receive units (WTRUS) A, B, C, D, E, F, a base station, a V2X server, and a RSUs A and B, though it will be appreciated that the disclosed embodiments contemplate any number of WTRUs, base stations, networks, and/or network elements. One or several or all WTRUs A, B, C, D, E may be out of range of the network (for example, in the figure out of the cell coverage boundary shown as the dash line). WTRUs A, B, C form a V2X group, among which WTRU A is the group lead and WTRUs B and C are group members. WTRUs A, B, C, D, E, F may communicate over Uu interface or Sidelink (PC5) interface.

It is understood that any or all of the apparatuses, systems, methods and processes described herein may be embodied in the form of computer executable instructions (e.g., program code) stored on a computer-readable storage medium which instructions, when executed by a processor, such as processors 118 or 91, cause the processor to perform and/or implement the systems, methods and processes described herein. Specifically, any of the steps, operations or functions described herein may be implemented in the form of such computer executable instructions, executing on the processor of an apparatus or computing system configured for wireless and/or wired network communications. Computer readable storage media include volatile and nonvolatile, removable and non-removable media implemented in any non-transitory (e.g., tangible or physical) method or technology for storage of information, but such computer readable storage media do not include signals. Computer readable storage media include, but are not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other tangible or physical medium which may be used to store the desired information and which may be accessed by a computing system.

What is claimed is:

1. A method comprising:
receiving, by a first service enabler architecture layer for data delivery (SEALDD) server and from a SEALDD client, a request to establish a SEALDD flow, wherein the SEALDD flow facilitates a transfer of vertical application layer (VAL) data between a VAL client endpoint and a first VAL server endpoint, and wherein the request comprises at least one of VAL client endpoint information and first VAL server endpoint information;
processing, by the first SEALDD server, the request by establishing a SEALDD flow associated with the first VAL server and associated with at least one VAL client endpoint specified in the request;
subscribing, by the first SEALDD server, to a core network;
receiving, by the first SEALDD server and based on the subscribing to the core network, a notification from the core network indicating a user equipment (UE) mobility event associated with a UE upon which the VAL client is hosted;
determining to transfer the VAL client to a second VAL server based on the mobility event; and
transferring, by the first SEALDD server, the SEALDD flow to a second SEALDD server associated with the second VAL server.

2. The method of claim 1, further comprising a SEALDD flow identifier assigned by the SEALDD client.

3. The method of claim 1, wherein the VAL client endpoint information and the VAL server endpoint information further comprise at least one of a VAL client identifier, an internet protocol (IP) address, a port, or a uniform resource locator (URL).

4. The method of claim 1, wherein transferring the SEALDD flow to the second SEALDD server further comprises the first SEALDD server sending a request to push SEALDD flow information to the second SEALDD server.

5. The method of claim 1, wherein transferring the SEALDD flow to the second SEALDD server further comprises the second SEALDD server sending a request to pull SEALDD flow information from the first SEALDD server.

6. The method of claim 1, wherein transferring the SEALDD flow to the second SEALDD server further comprises sending, by the first SEALDD server, a SEALDD flow identifier to the second SEALDD server.

7. The method of claim 1, further comprising sending a response to the SEALDD client comprising an indication of successful establishment of the SEALDD flow.

8. The method of claim 1, further comprising sending a response to the SEALDD client comprising at least one of a first SEALDD server IP address or a first SEALDD server uniform resource identifier (URI).

9. A first service enabler architecture layer for data delivery (SEALDD) server apparatus comprising:
one or more processors; and
memory storing instructions that, when executed by the one or more processors, cause the first SEALDD server apparatus to:
receive, from a SEALDD client, a request to establish a SEALDD flow, wherein the SEALDD flow facilitates a transfer of vertical application layer (VAL) data between a VAL client endpoint and a first VAL server endpoint, and wherein the request comprises at least one of VAL client endpoint information and first VAL server endpoint information;
process the request by establishing a SEALDD flow associated with the first VAL server and associated with at least one VAL client endpoint specified in the request;
subscribe to a core network;
receive, based on the subscribing to the core network, a notification from the core network indicating a user equipment (UE) mobility event associated with a UE upon which the VAL client is hosted;
determine to transfer the VAL client to a second VAL server based on the mobility event; and
transfer the SEALDD flow to a second SEALDD server associated with the second VAL server.

10. The apparatus of claim 9, further comprising a SEALDD flow identifier assigned by the SEALDD client.

11. The apparatus of claim 9, wherein the VAL client endpoint information and the VAL server endpoint information further comprise at least one of a VAL client identifier, an internet protocol (IP) address, a port, or a uniform resource locator (URL).

12. The apparatus of claim 9, wherein causing the apparatus to transfer the SEALDD flow to the second SEALDD server further comprises causing the apparatus to send a request to push SEALDD flow information to the second SEALDD server.

13. The apparatus of claim 9, wherein causing the apparatus to transfer the SEALDD flow to the second SEALDD server further comprises the second SEALDD server sending a request to pull SEALDD flow information from the apparatus.

14. The apparatus of claim 9, wherein causing the apparatus to transfer the SEALDD flow to the second SEALDD server further comprises causing the apparatus to send a SEALDD flow identifier to the second SEALDD server.

15. The apparatus of claim 9, further comprising causing the first SEALDD server apparatus to send a response to the SEALDD client comprising an indication of successful establishment of the SEALDD flow.

16. The apparatus of claim 9, further comprising causing the first SEALDD server apparatus to send a response to the SEALDD client comprising at least one of a first SEALDD server apparatus IP address or a first SEALDD server apparatus uniform resource identifier (URI).

17. A method comprising:
sending, by a service enabler architecture layer for data delivery (SEALDD) client and to a first SEALDD server, a request to establish a SEALDD flow, wherein the SEALDD flow facilitates a transfer of vertical application layer (VAL) data between a VAL client endpoint and a VAL server endpoint, and wherein the request comprises at least one of VAL client endpoint information and VAL server endpoint information;
receiving an indication of an establishment of a SEALDD flow associated with the VAL server and with at least one VAL client endpoint specified in the request;
determining occurrence of a user equipment (UE) mobility event of a UE upon which the VAL client is hosted; and
receiving, from the first SEALDD server, a transfer of the SEALDD flow to a second SEALDD server associated with the VAL server.

18. The method of claim 17, further comprising a SEALDD flow identifier assigned by the SEALDD client.

19. The method of claim 17, wherein the VAL client endpoint information and the VAL server endpoint information further comprise at least one of a VAL client identifier, an internet protocol (IP) address, a port, or a uniform resource locator (URL).

20. The method of claim 17, further comprising receiving, from the first SEALDD server, at least one of an indication of successful establishment of the SEALDD flow, a first SEALDD server IP address, or a first SEALDD server uniform resource identifier (URI).
